(19) United States
(12) Patent Application Publication
(10) Pub. No.: US 2025/0192617 A1
(43) Pub. Date: Jun. 12, 2025

(54) Wireless Power Receiver With Data Transceiver Capabilities For Communication With Passive Devices

(71) Applicant: NuCurrent, Inc., Chicago, IL (US)

(72) Inventors: Alberto Peralta, Chicago, IL (US); Jason Luzinski, Chicago, IL (US); Piotr Mikrut, Palatine, IL (US)

(21) Appl. No.: 18/535,648

(22) Filed: Dec. 11, 2023

(51) Int. Cl. H02J 50/23; H02J 50/10; H02J 50/27; H02J 50/80; H04B 5/43; H04B 5/79

(52) U.S. Cl. CPC H02J 50/23; H02J 50/27; H02J 50/80; H04B 5/43; H04B 5/79; H02J 50/10

(57) ABSTRACT

A wireless power receiver system utilizes near-field magnetic induction (NFMI) to receive wireless power signals and receive or transmit wireless data signals in-band of a carrier signal. The wireless power receiver system includes an antenna, a power conditioning system, and a controller. The antenna is configured to receive wireless power signals and transmit polling signals. The power conditioning system is configured to receive the wireless power signals and convert the wireless power signals to electrical energy for powering a load associated with the wireless power receiver system. The controller includes a driver, at least one first machine-readable medium, and program instructions stored on the at least one first non-transitory machine-readable medium that are executable by the controller such that the controller is configured to provide polling driving signals to the driver for generating the polling signals.

### TECHNICAL FIELD

The present disclosure generally relates to systems and methods for wireless transfer of electrical power and/or electrical data signals, and, more particularly, to wireless power receiver systems that have additional functionality for communicating with passive devices.

### BACKGROUND

Wireless connection systems are used in a variety of applications for the wireless transfer of electrical energy, electrical power, electromagnetic energy, and/or electrical data signals, among other known wirelessly transmittable signals. Such systems often use inductive wireless power transfer, which occurs when magnetic fields created by a transmitting element induce an electric field, and hence, an electric current, in a receiving element. These transmitting and receiving elements will often take the form of an antenna, such as coiled wires, and the like.

### SUMMARY

Near field magnetic induction (NFMI) is used for both near-field data communications (e.g., Near Field Communications (NFC) based communications systems) and for wireless power transfer (e.g., Qi wireless power systems, AirFuel-based wireless power systems, NFC Wireless Lan Controller (NFC-WLC) based wireless power systems, proprietary NFMI-based wireless power systems, and the like). NFMI, which also may be referenced as “near-field magnetic coupling,” enables the transfer of signals wirelessly through magnetic induction between a transmitter antenna and a receiving antenna of, or associated with, a wireless receiver system. NFMI may be and/or be referred to as “inductive coupling,” which, as used herein, is a wireless power transmission technique that utilizes an alternating electromagnetic field to transfer electrical energy between two antennas.

NFMI utilizes coupling between antennas, in the near field, for wireless transmission of magnetic energy between two magnetically coupled coils that are tuned to resonate at a similar frequency. Accordingly, such near-field magnetic coupling may enable wireless power transmission via resonant transmission of confined magnetic fields. Such near-field magnetic coupling may provide connection via “mutual inductance,” which, as defined herein is the production of an electromotive force in a circuit by a change in current in at least one other circuit magnetically coupled to the first.

To facilitate NFMI, the inductor coils of either the transmitter antenna or the receiver antenna are strategically positioned to facilitate reception and/or transmission of wirelessly transferred electrical signals, via NFMI.

Transmission of one or more of electrical energy, electrical power, electromagnetic energy and/or electronic data signals from one of such coiled antennas to another, generally, operates at an operating frequency and/or an operating frequency range. The operating frequency may be selected for any of a variety of reasons, such as, but not limited to, power transfer efficiency characteristics, power level characteristics, self-resonant frequency restraints, design requirements, adherence to standards bodies' required characteristics (e.g, electromagnetic interference (EMI) requirements, specific absorption rate (SAR) requirements, etc.), bill of materials (BOM) restrictions, and/or form factor constraints, among other things. It is to be noted that, “self-resonating frequency,” as known to those having skill in the art, generally refers to the resonant frequency of a passive component (e.g., an inductor) due to the parasitic characteristics of the component.

Antenna operating frequencies may comprise relatively high operating frequency ranges, examples of which may include, but are not limited to, 6.78 MHz (e.g., in accordance with the Rezence and/or Airfuel interface standard and/or any other proprietary interface operating at a frequency of 6.78 MHz), 13.56 MHz (e.g., in accordance with the NFC standard, defined by ISO/IEC standard 18092), 27 MHz, and/or an operating frequency of another proprietary operating mode. Such operating frequencies of the antennas may be operating frequencies designated by the International Telecommunications Union (ITU) in the Industrial, Scientific, and Medical (ISM) frequency bands, which may include the aforementioned 6.78 MHz, 13.56 MHz, and 27 MHz frequency bands, which are designated for use in wireless power transfer. In systems wherein a wireless power transfer system is operating within the NFC-WLC standards and/or draft standards, the operating frequency may be in a range of about 13.553 MHz to about 13.567 MHz.

When such systems are operating to wirelessly transfer power from a transmission system to a receiver system via the antennas, it is often desired to simultaneously and/or at a different time communicate electronic data between the systems. In some example systems, wireless-power-related communications (e.g., validation procedures, electronic characteristics data, voltage data, current data, device type data, among other contemplated data communications related to wireless power transfer) are performed using in-band communications. However, it is certainly possible that the connection of devices, via NFMI, may be utilized in transferring data, over the coupled antennas, that is not related to the instant wireless power transfer and such data transfer may utilize the NFMI connection as a “pass through” or other data connection medium, for transferring data to/from a device operatively associated with the wireless receiver system.

“In-band communications,” as defined herein, refers to communications signals that are encoded in a carrier signal that is generated via coupling of two or more antennas. In-band communications, as utilized by NFMI systems, are communication signals that are encoded into the induced signal between antennas that are coupled via NFMI. In some examples, in-band communications signals are encoded by modulating a carrier signal (e.g. a wireless power signal or a polling signal) between coupled transmitter and receiver antennas, by a system selectively damping the induced signal. Either the transmitting or receiving system of an NFMI coupled pair may selectively damp the signal, to encode the in-band signals.

Particularly, in some examples, in-band communication signals in an NFMI system are encoded as amplitude shift keyed (ASK) signals, which, in some examples, may include on-off-keyed (OOK) signals, which are a subset of ASK signals. In an ASK signal, the wireless data signals are encoded by damping the voltage of the magnetic field between a wireless transmission system and a wireless receiver system. Such damping and subsequent re-rising of the voltage in the field is performed based on an underlying encoding scheme for the wireless data signals (e.g., binary coding, Manchester coding, pulse-width modulated coding, among other known or novel coding systems and methods). The receiver of the wireless data signals (e.g., a wireless transmission system in this example) can then detect rising and falling edges of the voltage of the induced field and decode said rising and falling edges to demodulate the wireless data signals.

While the above has, generally, discussed NFMI and wireless power and data transfer, relative to data and/or power transfer between two active electronic devices or circuits (e.g., a wireless transmission system, a wireless receiver system), it is certainly possible to connect an active NFMI transmission system or circuit with a passive NFMI system or circuit. An “active” electronic system or circuit refers an electronic system wherein at least one portion of the electronic circuit requires a consistent external power source (e.g., a plug to an outlet, a battery, etc.) to function properly. To that end, an active electronic system may be an electronic system or circuit that is physically wired, whether via removable means, permanent means, or semi-permanent means, to a source of electrical energy, such as a power supply connected to a power source and/or a battery for power input to the active electronic system or circuit.

A “passive” electronic system or circuit refers to an electronic system that capable of sustaining functionality off of energy harvested from an external magnetic field or similar wireless signal, such as, for example, energy harvested via NFMJ. To that end, a passive electronic system or circuit may be an electronic system or circuit that is not physically connected, on a permanent or semi-permanent basis, to a source of electrical energy, such as a wire connected to a power source or a battery.

While described as differing systems, it is certainly contemplated that an electronic system may be configured to operate as an active electronic system in some use cases, while also being configured to operate as a passive electronic system in some other use cases.

For example, a passive NFMI device or circuit may be an electronic system or circuit that includes an antenna configured for receipt of power, via NFMI, from a transmitting system. Said transmitting system is configured to couple with the antenna of the passive NFMI device or circuit. In such devices, the power harvested by the NFMI device or circuit, from NFMI coupling with the transmission system, is then used to power electronic components of the passive NFMI device or circuit. Said powering of the electronic components may occur while the antenna of the passive NFMI device is coupled with the transmission device and/or may occur for a short period of time thereafter. In examples wherein the passive NFMI device remains powered for a period of time after decoupling, the passive NFMI device may include a capacitor that is configured to harvest power via the NFMI connection. In such examples, the capacitor may, then, discharge said harvested power after the NFMI connection is disconnected and/or the antennas are decoupled.

An example of a passive NFMI system is a passive listener or passive tag device, such as, but not limited to, an NFC tag that operates without constant connection to a source of electrical energy. Passive devices may be utilized as affordable, portable circuits for storing some set of data for use, when the passive device is placed in the proximity of a polling device. A “polling device,” as defined herein, is an NFMI device that is capable of transmitting at least some electrical energy, to power a passive NFMI system, such that the passive NFMI system, subsequent to energy transfer, is capable of performing some electrical function. For example, a passive NFMI device or circuit may include an antenna connected to a controller or other microprocessor that includes memory storage, which may include at least one non-transitory machine-readable medium. In such examples, the memory storage may include data associated with a host device for the passive NFMI device or circuit and, when the passive NFMI device or circuit is electrically activated by a polling device, the passive NFMI device or circuit is configured to modulate a polling signal received by the passive NFMI device. Such modulation may be configured to encode at least some of the data associated with the host device into the polling signal, as in-band communications, such that the at least some data is receivable by the poling device or a host device thereof.

Passive NFMI systems, circuits, and/or devices are relatively common in modem life. For example, many modern payment cards (e.g., credit cards, debit cards, and the like) include a passive NFMI circuit for use in contactless and/or “tap to pay” payment systems. In such examples, a payment terminal and/or card reader acts as the NFMI polling device, which is associated with the type of passive NFMI circuit of the payment card. To that end, the payment terminal is configured to transmit a polling signal, which may be received by the passive NFMI circuit of the payment card, to initialize the passive NFMI circuit. Then, the payment card is capable of securely encoding a unique identifier in the polling signal, which is transmitted by the NFMI polling device of the payment terminal and which, subsequently, allows the payment terminal to receive the unique identifier and connect a payment processor or payment processing service to a user account associated with the unique identifier. Thus, passive NFMI circuits are useful for affordable and secure payment processing, as the user device (e.g., a payment card) does not need any active components and is of small enough size to be easily embedded in the form factor of a traditional payment card.

Further, still, passive NFMI devices are commonly utilized for locks or other security and/or entry systems. For example, consider a modem lodging or hotel experience: the guest is, most often, given a key card for entry to a room or other residence. In some such examples, the guest is instructed to hold the key card near or to tap a location on a door, or handle thereof, associated with the room or other residence. Then, once an electronic device associated with the door recognizes and verifies that the key card is associated with the guest, who is staying in the room, the electronic device, then, may electronically open the door or instruct another electronic device for unlocking or otherwise opening the door.

In such examples, the electronic device associated with the door may include an NFMI polling device and the key card may include a passive NFMI circuit and, similar to the payment card example, the passive NFMI circuit may include memory storage that stores a unique identifier associated with the guest staying in the room associated with the door. Accordingly, the passive NFMI device of the keycard may be configured to receive polling signals from the NFMI polling device, activate electronic components in response to receipt of the polling signals, and encode unique identifier into the polling signals as in-band communications signals of the polling signals. Then, the NFMI polling device may receive and/or decode the in-band communications signals to, then, receive the unique identifier, which may then be verified or denied by the electronic device associated with the NFMI polling device, for locking and/or unlocking the door.

Alternatively, in some lock use cases, the lock itself may be associated with a passive NFMI circuit. In such examples, the lock may be activated or otherwise initialized by a NFMI polling device external to the lock or any electronics thereof. For example, a lock with a passive NFMI circuit may be activated by polling signals that are transmitted from a NFMI polling device associated with a portable electronic device, such as a mobile device (e.g., a mobile phone). In such examples, the passive NFMI device of the lock may include a controller and associated memory storage, which stores identification and/or identification verification information. The NFMI polling device of or associated with the mobile device may include identifying information, which is transmitted to the passive NFMI device, in-band of a polling signal transmitted by the NFMI polling device. In some examples, the controller of the passive NFMI device may analyze the received identifying information, in view of the identification and/or identification verification information, to determine if the lock can be unlocked by the user of the mobile device.

In examples of locks with a passive NFMI device, if the analysis determines the lock can be unlocked by the user, then the passive NFMI device may harvest power from the polling signal and/or other NFMI signals output by the NFMI polling device for unlocking or locking the lock. In some such examples, the harvested power may activate a motor and/or an actuator which mechanically unlocks a locking mechanism of the lock. In some such examples, the passive NFMI device and/or any associated circuits of the lock may include a capacitor that receives the harvested power and temporarily stores said harvested power, for powering a mechanical component of the lock, such as a motor or actuator. Capacitors used for said functions may include, but are not limited to including, super capacitors, electrolytic capacitors, multi-layer ceramic capacitors, and the like.

Another example of use for passive NFMI devices or circuits is in identifying locations and/or objects relative to a body of one of a human, an animal, or other living being. To that end, passive NFMI devices may be or be included in devices worn, attached to, implanted in, and/or otherwise associated with a body of one or a human, an animal, or other living being. For example, a passive NFMI circuit may be attached to or otherwise associated with a location on a body and the passive NFMI circuit can be polled by an NFMI poller, which will receive or derive information associated with the location on the body.

In examples wherein the passive NFMI circuit is or is associated with an implanted device within a body of a human, an animal, or other living being, the NFMI poller may be utilized to verify location of a medical device associated with the passive NFMI circuit. For example, implanted medical devices often shift position, over the course of use in an implanted fashion, and the NFMI poller may be utilized in verifying positioning, via receiving identifying information, via in-band communications over the polling signal.

Further still, a passive NFMI circuit may be utilized as a connection for wireless power harvesting via NFMI. Thus, by utilizing the passive NFMI circuit for wireless power harvesting, a device that requires power may utilize the passive NFMI circuit as a power source and, for example, the passive NFMI circuit may be a replacement for a battery or other power source.

One or more of the aforementioned functions, among other functions, for utilizing NFMI polling of passive NFMI circuits, may be utilized by wearable electronic devices (e.g., a watch, a smart watch, a fitness tracker, an electronic ring, electronic glasses, heart rate monitors, chest straps, ankle monitors, and the like), wherein a wireless charging component is utilized as an NFMI poller. Wireless charging for wearable devices is advantageous for removing exposed electronic ports or pins (e.g., pogo pins, spring loaded pins, universal serial bus (USB) ports, proprietary wired electronic inputs or contacts, and the like), which are often the most reported source of failure for a given electronic device. Accordingly, many modern wearable electronic devices utilize NFMI for wireless charging and, accordingly, wireless charging enables said devices to be fully sealed, from the elements, such as water ingress, debris ingress, and the like.

Wearable electronic devices, generally, have a more desirable user experience, if the wearable electronic device is not burdensomely heavy, which may result in an uncomfortable user experience. Further still, device weight and BOM may go hand-in-hand; thus, any reduction of BOM or reduction in necessary components in any electronic device, may result in lower cost for the manufacturer when producing the electronic device.

To that end, in electronic devices, it may be advantageous to utilize a wireless power receiver system, to provide wireless power to the device, wherein the wireless power receiver system is configured with additional functionality as an NFMI polling device. In practice, some components utilized for an NFMI polling device may be the same or similar to necessary components utilized for a wireless power receiver device. As component costs continue to rise and/or such components become more scarce, it may be advantageous to utilize common components to implement different functionalities. Further still, utilizing common physical components to implement differing systems or functions may reduce the bill of material (BOM) of a circuit or device and/or may reduce the size or footprint of said circuit or device.

In such examples, additional communications functionality for the electronic device may be desired, such as capabilities for reading data from and/or otherwise communicatively coupling with passive electronic devices, such as passive NFMI devices. In some such examples, a common, similar, or related data communications protocol (e.g. NFC communications and/or NFC-WLC) may be utilized for wireless power transfer functionality and may be utilized for communications with a passive NFMI device. Therefore, common components of or for NFMI circuitry may be shared by systems, apparatus, and/or methods for NFMI polling and systems, apparatus, and/or methods for wireless power receipt, via NFMI.

To that end, the systems and methods disclosed herein provide for wireless power receiver systems that have data transceiver capabilities for communicating with passive NFMI devices. While the systems, methods, and apparatus disclosed herein may be discussed as utilizing an active NFMI polling device to communicate with passive NFMI devices, it is certainly contemplated that the systems, methods, and apparatus disclosed herein may be applicable in utilizing an active NFMI polling device to communicate with a NFMI device that is also active or otherwise powered.

Thus, in accordance with an aspect of the disclosure, a wireless power receiver system is disclosed. The wireless power receiver system includes an antenna, a power conditioning system, and a controller. The antenna is configured to receive wireless power signals and transmit polling signals. The power conditioning system is configured to receive the wireless power signals and convert the wireless power signals to electrical energy for powering a load associated with the wireless power receiver system. The controller includes a driver, at least one first machine-readable medium, and program instructions stored on the at least one first non-transitory machine-readable medium that are executable by the controller such that the controller is configured to provide polling driving signals to the driver for generating the polling signals.

In a refinement, transmitting the polling signals, by the antenna, includes transmitting the polling signals to a passive antenna of a passive communications system, the passive communications system including the passive antenna and a passive controller.

In a further refinement, the passive controller includes at least one second non-transitory machine-readable medium and program instructions stored on the second non-transitory machine-readable medium that are executable by the passive controller such that the passive controller is configured to modulate the polling signals to encode first data signals in-band of the polling signals.

In yet a further refinement, the program instructions stored on the at least one first non-transitory machine-readable medium further include instructions that are executable by the controller such that the controller is configured to demodulate the polling signals to decode the first data signals in-band of the polling signals.

In yet a further refinement, the program instructions stored on the at least one first non-transitory machine-readable medium further include instructions that are executable by the controller such that the controller is configured to store the first data signals on one or more of the at least one first non-transitory machine-readable medium, at least one other non-transitory machine-readable medium, or combinations thereof, and the at least one other non-transitory machine-readable medium is operatively associated with the wireless receiver system, a host device associated with the wireless power receiver system, or combinations thereof.

In another further refinement, receiving the wireless power signals, by the antenna, includes receiving the wireless power signals from a transmitter antenna of a wireless transmission system. The wireless transmission system includes a transmitter antenna and a transmitter controller. The transmitter controller includes at least one third non-transitory medium and program instructions stored on the at least one third non-transitory machine-readable medium that are executable by the transmitter controller such that the transmitter controller is configured to generate driving signals for driving the transmitter antenna to transmit the wireless power signals and modulate the driving signals to encode second data signals in-band of the wireless power signals.

In yet a further refinement, the program instructions stored on the at least one first non-transitory machine-readable medium further include instructions that are executable by the transmitter controller such that the transmitter controller is configured to demodulate the wireless power signals to decode the second data signals.

In yet a further refinement, the program instructions stored on the at least one first non-transitory machine-readable medium further include instructions that are executable by the transmitter controller such that the transmitter controller is configured to modulate the wireless power signals to encode third data signals in-band of the wireless power signals.

In yet a further refinement, the first data signals are first asynchronous serial data signals and the second data signals are second asynchronous serial data signals, and each of the first and second asynchronous serial data signals are compliant with a wireless power and data transfer protocol.

In yet a further refinement, the first asynchronous serial data signals are first universal asynchronous receiver-transmitter (UART) compliant data signals and the second asynchronous serial data signals are second UART compliant data signals.

In yet a further refinement, the wireless power and data transfer protocol is a Near Field Communication (NFC) transfer protocol.

In another refinement, the wireless receiver system further includes a switch, the switch including a first switch position and a second switch position, the first switch position configured to connect the antenna to the controller via a first signal path and the second switch position configured to connect the antenna to the receiver controller via a second signal path.

In a further refinement, the first signal path directs the wireless power signals towards, at least, the controller.

In yet a further refinement, the second signal path carries the polling signals from the controller to the antenna.

In yet a further refinement, the controller is connected to the antenna via a third signal path and the controller is configured to modulate one or more of the wireless power signals, the polling signals, or combinations thereof, via the third signal path.

In a further refinement, the program instructions stored on the at least one first non-transitory machine-readable medium are executable by the controller such that the controller is further configured to provide switching instructions to the switch to direct the switch to the first position, when wireless power receipt desired.

In yet a further refinement, the program instructions stored on the at least one first non-transitory machine-readable medium are executable by the controller such that the controller is further configured to receive power instructions from at least one host controller of a host device of the wireless receiver system and wherein the switching instructions are provided to the controller in response to the power instructions.

In yet a further refinement, the at least one host controller comprises a power management integrated circuit (PMIC).

In a further refinement, the program instructions stored on the at least one first non-transitory machine-readable medium are executable by the controller such that the controller is further configured to provide switching instructions to the switch to direct the switch to the second position, when polling for wireless communications is desired.

In yet a further refinement, the program instructions stored on the at least one first non-transitory machine-readable medium are executable by the controller such that the controller is further configured to receive communications instructions from at least one host controller of a host device of the wireless receiver system and wherein the switching instructions are provided to the controller in response to the communications instructions.

In a refinement, the antenna includes a first antenna and a second antenna, the first antenna configured to receive the wireless power signals and the second antenna configured to transmit the polling signals.

In a further refinement, the wireless receiver system further includes a first switch, the switch including a first switch position and a second switch position, the first switch position configured to connect the controller to a first signal path and the second switch position configured to connect the controller to a second signal path. The wireless receiver system further includes a second switch, the second switch including a third switch position and a fourth switch position, wherein the third switch position is configured to connect the controller to the first antenna, when the first switch is in the first switch position, and wherein the fourth switch position is configured to connect the controller to the second antenna, when the first switch is in the second switch position.

In a refinement, the wireless power signals and the polling signals each operate at an operating frequency in a range of about 13.553 megahertz (MHz) to about 13.567 MHz.

In accordance with another aspect of the disclosure, a wireless power and data transfer system is disclosed. The wireless power and data transfer system includes a wireless transmission system, a passive communications system, and a wireless receiver system. The wireless transmission system includes a transmitter antenna for transmitting wireless power signals and a transmitter controller. The transmitter controller includes at least one first non-transitory machine-readable medium and program instructions stored on the at least one first non-transitory machine-readable medium that are executable by the transmitter controller such that the transmitter controller is configured to generate driving signals for driving the transmitter antenna to transmit the wireless power signals. The passive communications system includes a passive antenna and a passive controller. The passive controller includes at least one second non-transitory machine-readable medium and program instructions stored on the second non-transitory machine-readable medium that are executable by the passive controller such that the passive controller is configured to modulate polling signals to encode first data signals in-band of the polling signals. The wireless receiver system includes a receiver antenna, a power conditioning system, and a receiver controller. The receiver antenna is configured to receive the wireless power signals and transmit the polling signals. The power conditioning system is configured to receive the wireless power signals and convert the wireless power signals to electrical energy for powering a load associated with the wireless power receiver system. The receiver controller includes a driver, at least one third non-transitory machine-readable medium, and program instructions stored on the at least one third non-transitory machine-readable medium that are executable by the receiver controller such that the receiver controller is configured to provide polling driving signals to the driver for generating the polling signals.

In a refinement, the passive communication system further comprises a rectifier for converting the polling signal into usable electrical energy for powering the passive controller.

In a refinement, the program instructions stored on the at least one third non-transitory machine-readable medium further include instructions that are executable by the receiver controller such that the controller is configured to demodulate the polling signals to decode the first data signals in-band of the polling signals.

In a further refinement, the program instructions stored on the at least one third non-transitory machine-readable medium further include instructions that are executable by the receiver controller such that the receiver controller is configured to store the first data signals on one or more of the at least one third non-transitory machine-readable medium, at least one other non-transitory machine-readable medium, or combinations thereof and the at least one other non-transitory machine-readable medium is operatively associated with the wireless receiver system, a host device associated with the wireless power receiver system, or combinations thereof.

In a refinement, the program instructions stored on the at least one first non-transitory machine-readable medium further includes instructions that are executable by the transmitter controller such that the transmitter controller is configured to modulate the driving signals to encode second data signals in-band of the wireless power signals.

In a further refinement, the program instructions stored on the at least one third non-transitory machine-readable medium further include instructions that are executable by the receiver controller such that the receiver controller is configured to demodulate the wireless power signals to decode the second data signals.

In yet a further refinement, the program instructions stored on the at least one third non-transitory machine-readable medium further include instructions that are executable by the receiver controller such that the receiver controller is configured to modulate the wireless power signals to encode data signals in-band of the wireless power signals.

In yet a further refinement, the wireless power signals and the polling signals each operate at an operating frequency selected from one or more of a first operating frequency, a second operating frequency, a third operating frequency, or combinations thereof. The first operating frequency is in a range of about 13.553 megahertz (MHz) to about 13.567 MHz. The second operating frequency is about 6.78 MHz. The third operating frequency is in a range of about 88 kilohertz (kHz) to about 1 MHz.

In a refinement, one or more of the passive communications system, the wireless receiver system, or combinations thereof is operatively associated with a locking mechanism.

In a refinement, the passive communications system is operatively associated with one of a plurality of locations, each of the plurality of locations being located in or on an environment, and wherein the first data signals include location-based identifying signals associated with one of the plurality of locations in or on the environment.

In a further refinement, the program instructions stored on the at least one third non-transitory machine-readable medium are executable by the receiver controller such that the receiver controller is configured to demodulate the identification signals from the polling signals and provide the identification signals to a host controller of a host device associated with the wireless receiver system.

In yet another aspect of the disclosure, a locking device is disclosed. The locking device includes a locking mechanism and a wireless receiver system. The locking mechanism includes a mechanical lock configured to switch between a locked and an unlocked position and a lock controller configured to control the mechanical lock in response to verification instructions provided by the wireless receiver system. The wireless receiver system an antenna, a power conditioning system, and a controller. The antenna is configured to receive wireless power signals and wireless data signals. The power conditioning system is configured to receive the wireless power signals and convert the wireless power signals to electrical energy for powering a load associated with the locking mechanism. The controller includes at least one first machine-readable medium, and program instructions stored on the at least one first non-transitory machine-readable medium that are executable by the controller such that the controller is receive the wireless power signals, decode verification instructions from the wireless data signals. The lock controller may be configured to provide instructions to the mechanical lock to switch the mechanical lock between the locked and unlocked position.

In a refinement, the load associated with the locking mechanism includes a capacitor.

In a further refinement, the capacitor is a super capacitor.

In a further refinement, powering the load associated with the locking mechanism includes directly powering the mechanical lock in response to instructions from the lock controller.

In yet a further refinement, powering the load associated with the locking mechanism includes directly powering an actuator of the mechanical lock in response to instructions from the lock controller.

In yet a further refinement, the host controller is configured to alter operations of the host device based on the received identification signals.

In a refinement, the wireless power receiver further includes a voltage isolation circuit. The voltage isolation circuit includes at least two capacitors, wherein the at least two capacitors are in electrical parallel with respect to the controller capacitor. The voltage isolation circuit is configured to (i) regulate the AC wireless power signal to have a voltage input range for input to the receiver controller and (ii) isolate a controller voltage at the receiver controller from a load voltage at the load associated with the wireless receiver system.

In a further refinement, the wireless power receiver further includes a capacitor configured for scaling the AC wireless power signal at the controller voltage, as altered and received from the voltage isolation circuit.

In a yet a further refinement, the wireless power receiver further includes a shunt capacitor in electrical parallel with the receiver antenna.

In another further refinement, a first capacitance (CISO1) of a first capacitor of the at least two capacitors and a second capacitance (CISO2) of a second capacitor of the at least two capacitors are configured such that:

$$CISO 1 ‖ CISO 2 = CTOTAL$$

wherein CTOTAL is a total capacitance for the voltage isolation circuit, and wherein CTOTAL is a constant configured for the voltage input range for input to the controller.

In yet a further refinement, the values for the first capacitance and the second capacitance are set such that:

$${C}_{ISO 1} = \frac{{C}_{TOTAL} * ( 1 + {t}_{v} )}{{t}_{V}} , \\ {C}_{ISO 2} = {C}_{TOTAL} * ( 1 + {t}_{v} ) .$$

In a yet a further refinement, tᵥ is in a scaling factor in a range of about 1 to about 10.

These and other aspects and features of the present disclosure will be better understood when read in conjunction with the accompanying drawings.

### BRIEF DESCRIPTION OF THE DRAWINGS

FIG. 1 is a block diagram of an embodiment of a system for wirelessly transferring one or more of electrical energy, electrical power signals, electrical power, electromagnetic energy, electronic data, and combinations thereof, in accordance with the present disclosure.

FIG. 2 is a block diagram illustrating components of a wireless transmission system of the system of FIG. 1 and a wireless receiver system of the system of FIG. 1, in accordance with FIG. 1 and the present disclosure.

FIG. 3 is a block diagram illustrating components of a transmission control system of the wireless transmission system of FIG. 2, in accordance with FIG. 1, FIG. 2, and the present disclosure.

FIG. 4 is a block diagram illustrating components of a sensing system of the transmission control system of FIG. 3, in accordance with FIGS. 1-3 and the present disclosure.

FIG. 5 is a block diagram illustrating components of a power conditioning system of the wireless transmission system of FIG. 2, in accordance with FIG. 1, FIG. 2, and the present disclosure.

FIG. 6 is a block diagram of elements of the wireless transmission system of FIGS. 1-5, further illustrating components of an amplifier of the power conditioning system of FIG. 5 and signal characteristics for wireless power transmission, in accordance with FIGS. 1-5 and the present disclosure.

FIG. 7 is an electrical schematic diagram of elements of the wireless transmission system of FIGS. 1-6, further illustrating components of an amplifier of the power conditioning system of FIGS. 5-6, in accordance with FIGS. 1-6 and the present disclosure.

FIG. 8 is an exemplary plot illustrating rise and fall of “on” and “off” conditions when a signal has in-band communications via on-off keying.

FIG. 9 is a block diagram illustrating components of a receiver control system and a receiver power conditioning system of the wireless receiver system of FIG. 2, in accordance with FIG. 1, FIG. 2, and the present disclosure.

FIG. 10A is a block diagram of elements of the wireless receiver system of FIGS. 1, 2, and 9, illustrated in a first operating state, illustrating signal characteristics for wireless power receipt and data communications, in accordance with FIGS. 1-9 and the present disclosure.

FIG. 10B is another block diagram of elements of the wireless receiver system of FIGS. 1, 2, and 9-10A, illustrated in a second operating state, illustrating signal characteristics for communications polling and data communications, in accordance with FIGS. 1-10A and the present disclosure.

FIG. 11A is a first electrical schematic diagram of elements of the wireless receiver system of FIGS. 1, 2, and 9-10B, further illustrating components in signal paths associated with the first operating state, in accordance with FIGS. 1-10B and the present disclosure.

FIG. 11B is a second electrical schematic diagram of elements of the wireless receiver system of FIGS. 1, 2, and 9-11A, further illustrating components in signal paths associated with the second operating state, in accordance with FIGS. 1-11A and the present disclosure.

FIG. 12 is a schematic diagram for an embodiment of an antenna for use with the wireless receiver system(s) of FIGS. 1, 2, and 10A-11B, in accordance with FIGS. 1-11B and the present disclosure.

FIG. 13 is a block diagram of a passive communications system, in accordance with FIGS. 1-12 and the present disclosure.

FIG. 14 is an example map with block diagram elements, illustrating one or more passive communications devices, each present in, on, or within a respective location within an environment, in accordance with FIGS. 1-13 and the present disclosure.

FIG. 15 is schematic functional plot of UART serial wired components overlaid with example communications, by way of background.

FIG. 16 is timing diagram showing packet communications over UART serial wired communications, by way of background.

FIG. 17 is a timing diagram showing encapsulation of wirelessly transmitted data, in accordance with the present disclosure.

FIG. 18 is a timing diagram showing receiver and transmitter timing functions, in accordance with the present disclosure.

FIG. 19 is a timing diagram showing windowing of communications, when both the wireless transmission system and the wireless receiver system are communicating with virtual two-way communications, in accordance with the present disclosure.

FIG. 20 is a timing diagram showing variable-length windowing of communications, when both the wireless transmission system and the wireless receiver system are communicating with virtual two-way communications, in accordance with the present disclosure.

FIG. 21 is a schematic diagram of a system segment for buffering data communication for transmission and receipt via near-field magnetic coupling, in accordance with the present disclosure.

FIG. 22 is a set of vertically-registered timing diagrams reflecting buffered data communications, in accordance with the present disclosure.

FIG. 23 is a block diagram for an example locking system that utilizes a wireless system for operating locking functions, in response to wireless power and data receipt, in accordance with FIGS. 1-23 and the present disclosure. disclosure.

FIG. 24 is a top view of a non-limiting, exemplary antenna, for use as one or both of a transmission antenna and a receiver antenna of the systems, methods, or apparatus disclosed herein, in accordance with the present.

While the following detailed description will be given with respect to certain illustrative embodiments, it should be understood that the drawings are not necessarily to scale and the disclosed embodiments are sometimes illustrated diagrammatically and in partial views. In addition, in certain instances, details which are not necessary for an understanding of the disclosed subject matter or which render other details too difficult to perceive may have been omitted. It should therefore be understood that this disclosure is not limited to the particular embodiments disclosed and illustrated herein, but rather to a fair reading of the entire disclosure and claims, as well as any equivalents thereto. Additional, different, or fewer components and methods may be included in the systems and methods.

### DETAILED DESCRIPTION

In the following description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings. For example, as noted above, UART is used herein as an example asynchronous communication scheme, and the NFC protocols are used as example synchronous communications scheme. However, other wired and wireless communications techniques may be used while embodying the principles of the present disclosure.

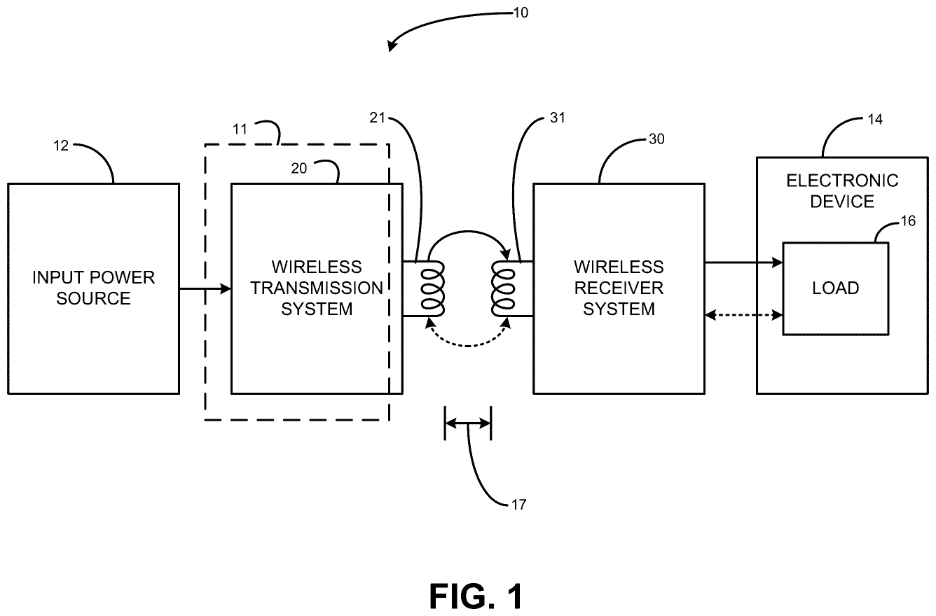

Referring now to the drawings and with specific reference to FIG. 1, a wireless power transfer system 10 is illustrated. The wireless power transfer system 10 provides for the wireless transmission of electrical signals, such as, but not limited to, electrical energy, electrical power, electrical power signals, electromagnetic energy, and electronically transmittable data (“electronic data”). As used herein, the term “electrical power signal” refers to an electrical signal transmitted specifically to provide meaningful electrical energy for charging and/or directly powering a load, whereas the term “electronic data signal” refers to an electrical signal that is utilized to convey data across a medium. Further still, “polling signals,” as defined herein, refer to electrical power signals having a sufficient power level to induce a current and act as a carrier signal for in-band wireless data signals. Optionally, polling signals may be harvested by components of a device receiving the polling signals. In some examples, polling signals may be harvested by passive electronic devices to provide electrical power for operating the passive electronic device.

The wireless power transfer system 10 provides for the wireless transmission of electrical signals via NFMI. As shown in the embodiment of FIG. 1, the wireless power transfer system 10 includes a wireless transmission system 20 and a wireless receiver system 30. The wireless receiver system is configured to receive electrical signals, via a receiver antenna 31, from a transmission antenna 21 of the wireless transmission system 20. In some examples, such as examples wherein the wireless power transfer system is configured for wireless power transfer via NFC-WLC draft or accepted standard, the wireless transmission system 20 may be referenced as a “poller” of the a NFC-DC wireless transfer system and the wireless receiver system 30 may be referenced as a “listener” of a NFC-DC wireless transfer system.

As illustrated, the wireless transmission system 20 and wireless receiver system 30 may be configured to transmit electrical signals across, at least, a separation distance or gap 17. A separation distance or gap, such as the gap 17, in the context of a wireless power transfer system, such as the system 10, does not include a physical connection, such as a wired connection. There may be intermediary objects located in a separation distance or gap, such as, but not limited to, air, a counter top, a casing for an electronic device, a plastic filament, an insulator, a mechanical wall, among other things; however, there is no physical, electrical connection at such a separation distance or gap.

Thus, the combination of the wireless transmission system 20 and the wireless receiver system 30 creates an electrical connection without the need for a physical connection. As used herein, the term “electrical connection” refers to any facilitation of a transfer of an electrical current, voltage, and/or power from a first location, device, component, and/or source to a second location, device, component, and/or destination. An “electrical connection” may be a physical connection, such as, but not limited to, a wire, a trace, a via, among other physical electrical connections, connecting a first location, device, component, and/or source to a second location, device, component, and/or destination. Additionally or alternatively, an “electrical connection” may be a wireless power and/or data transfer, such as, but not limited to, magnetic, electromagnetic, resonant, and/or inductive field, among other wireless power and/or data transfers, connecting a first location, device, component, and/or source to a second location, device, component, and/or destination.

In some cases, the gap 17 may also be referenced as a “Z-Distance,” because, if one considers an antenna 21, 31 each to be disposed substantially along respective common X-Y planes, then the distance separating the antennas 21, 31 is the gap in a “Z” or “depth” direction. However, flexible and/or non-planar coils are certainly contemplated by embodiments of the present disclosure and, thus, it is contemplated that the gap 17 may not be uniform, across an envelope of connection distances between the antennas 21, 31. It is contemplated that various tunings, configurations, and/or other parameters may alter the possible maximum distance of the gap 17, such that electrical transmission from the wireless transmission system 20 to the wireless receiver system 30 remains possible.

The wireless power transfer system 10 operates when the wireless transmission system 20 and the wireless receiver system 30 are coupled. As used herein, the terms “couples,” “coupled,” and “coupling” generally refer to magnetic field coupling, which occurs when a transmitter and/or any components thereof and a receiver and/or any components thereof are coupled to each other through a magnetic field. Such coupling may include coupling, represented by a coupling coefficient (k), that is at least sufficient for an induced electrical power signal, from a transmitter, to be harnessed by a receiver. Coupling of the wireless transmission system 20 and the wireless receiver system 30, in the system 10, may be represented by a resonant coupling coefficient of the system 10 and, for the purposes of wireless power transfer, the coupling coefficient for the system 10 may be in the range of about 0.01 to about 0.9.

As illustrated, the wireless transmission system 20 may be associated with a host device 11, which may receive power from an input power source 12. The host device 11 may be any electrically operated device, circuit board, electronic assembly, dedicated charging device, or any other contemplated electronic device. Example host devices 11, with which the wireless transmission system 20 may be associated therewith, include, but are not limited to including, a device that includes an integrated circuit, cases for wearable electronic devices, receptacles for electronic devices, a portable computing device, wearable charging devices, on-device chargers, clothing configured with electronics, storage medium for electronic devices, charging apparatus for one or multiple electronic devices, dedicated electrical charging devices, activity or sport related equipment, goods, and/or data collection devices, among other contemplated electronic devices.

As illustrated, one or both of the wireless transmission system 20 and the host device 11 are operatively associated with an input power source 12. The input power source 12 may be or may include one or more electrical storage devices, such as an electrochemical cell, a battery pack, and/or a capacitor, among other storage devices. Additionally or alternatively, the input power source 12 may be any electrical input source (e.g., any alternating current (AC) or direct current (DC) delivery port) and may include connection apparatus from said electrical input source to the wireless transmission system 20 (e.g., transformers, regulators, conductive conduits, traces, wires, equipment, computer, camera, mobile phone, and/or other electrical device connection ports and/or adaptors, such as but not limited to USB ports and/or adaptors, among other contemplated electrical components).

Electrical energy received by the wireless transmission system 20 is then used for at least two purposes: to provide electrical power to internal components of the wireless transmission system 20 and to provide electrical power to the transmission antenna 21. The transmission antenna 21 is configured to wirelessly transmit the electrical signals conditioned and modified for wireless transmission by the wireless transmission system 20 via NFMI.

The transmission antenna 21 and the receiver antenna 31 of the present disclosure may be configured to transmit and/or receive electrical power having a magnitude that ranges from about 10 milliwatts (mW) to about 500 watts (W). In one or more embodiments the inductor coil of the transmission antenna 21 is configured to resonate at a transmitting antenna resonant frequency or within a transmitting antenna resonant frequency band.

As known to those skilled in the art, a “resonant frequency” or “resonant frequency band” refers a frequency or frequencies wherein amplitude response of the antenna is at a relative maximum, or, additionally or alternatively, the frequency or frequency band where the capacitive reactance has a magnitude substantially similar to the magnitude of the inductive reactance. In one or more embodiments, the transmitting antenna resonant frequency is at a high frequency, as known to those in the art of wireless power transfer.

The wireless receiver system 30 may be associated with an example electronic device 14, wherein the electronic device 14 may be any device that requires electrical power for any function and/or for power storage (e.g., via a battery and/or capacitor). Additionally, the electronic device 14 may be any device capable of receipt of electronically transmissible data. For example, the device may be, but is not limited to being, a handheld computing device, a mobile device, a portable appliance, an integrated circuit, an identifiable tag, a kitchen utility device, an electronic tool, an electric vehicle, a game console, a robotic device, a wearable electronic device (e.g., an electronic watch, a fitness tracker, electronically modified glasses, altered-reality (AR) glasses, virtual reality (VR) glasses, among other things), a portable scanning device, a portable identifying device, a sporting good, an embedded sensor, an Internet of Things (IoT) sensor, IoT enabled clothing, IoT enabled recreational equipment, industrial equipment, medical equipment, a medical device, a tablet computing device, a portable control device, a remote controller for an electronic device, a gaming controller, among other things.

For the purposes of illustrating the features and characteristics of the disclosed embodiments, arrow-ended lines are utilized to illustrate transferrable and/or communicative signals and various patterns are used to illustrate electrical signals that are intended for power transmission and electrical signals that are intended for the transmission of data and/or control instructions. Solid lines indicate signal transmission of electrical energy over a physical and/or wireless power transfer, in the form of power signals that are, ultimately, utilized in wireless power transmission from the wireless transmission system 20 to the wireless receiver system 30. Further, dotted lines are utilized to illustrate electronically transmittable data signals, which ultimately may be wirelessly transmitted from the wireless transmission system 20 to the wireless receiver system 30.

While the systems and methods herein illustrate the transmission of wirelessly transmitted energy, wireless power signals, wirelessly transmitted power, wirelessly transmitted electromagnetic energy, and/or electronically transmittable data, it is certainly contemplated that the systems, methods, and apparatus disclosed herein may be utilized in the transmission of only one signal, various combinations of two signals, or more than two signals and, further, it is contemplated that the systems, method, and apparatus disclosed herein may be utilized for wireless transmission of other electrical signals in addition to or uniquely in combination with one or more of the above mentioned signals. In some examples, the signal paths of solid or dotted lines may represent a functional signal path, whereas, in practical application, the actual signal is routed through additional components en route to its indicated destination. For example, it may be indicated that a data signal routes from a communications apparatus to another communications apparatus; however, in practical application, the data signal may be routed through an amplifier, then through a transmission antenna, to a receiver antenna, where, on the receiver end, the data signal is decoded by a respective communications device of the receiver.

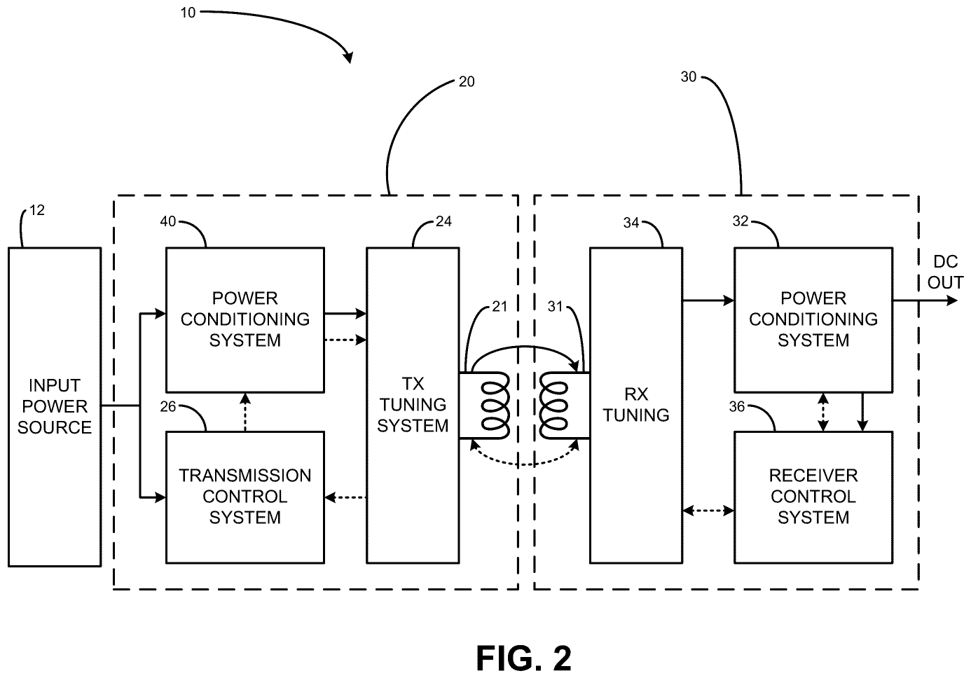

Turning now to FIG. 2, the wireless connection system 10 is illustrated as a block diagram including example sub-systems of both the wireless transmission system 20 and the wireless receiver system 30. The wireless transmission system 20 may include, at least, a power conditioning system 40, a transmission control system 26, a transmission tuning system 24, and the transmission antenna 21. A first portion of the electrical energy input from the input power source 12 is configured to electrically power components of the wireless transmission system 20 such as, but not limited to, the transmission control system 26. A second portion of the electrical energy input from the input power source 12 is conditioned and/or modified for wireless power transmission, to the wireless receiver system 30, via the transmission antenna 21. Accordingly, the second portion of the input energy is modified and/or conditioned by the power conditioning system 40. While not illustrated, it is certainly contemplated that one or both of the first and second portions of the input electrical energy may be modified, conditioned, altered, and/or otherwise changed prior to receipt by the power conditioning system 40 and/or transmission control system 26, by further contemplated subsystems (e.g., a voltage regulator, a current regulator, switching systems, fault systems, safety regulators, among other things).

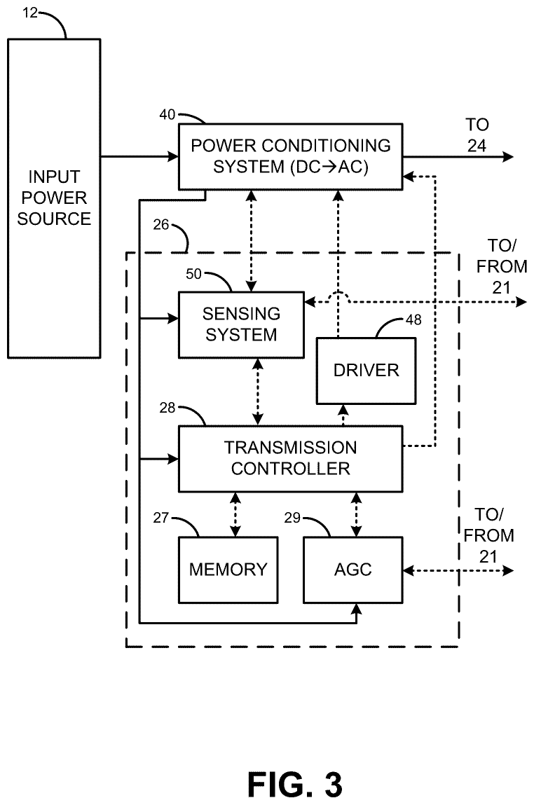

Referring now to FIG. 3, with continued reference to FIGS. 1 and 2, subcomponents and/or systems of the transmission control system 26 are illustrated. The transmission control system 26 may include a sensing system 50, a transmission controller 28, a communications system 29, a driver 48, and a memory 27.

The transmission controller 28 may be any electronic controller or computing system that includes, at least, a processor which performs operations, executes control algorithms, stores data, retrieves data, gathers data, controls and/or provides communication with other components and/or subsystems associated with the wireless transmission system 20, and/or performs any other computing or controlling task desired. The transmission controller 28 may be a single controller or may include more than one controller disposed to control various functions and/or features of the wireless transmission system 20. Functionality of the transmission controller 28 may be implemented in hardware and/or software and may rely on one or more data maps relating to the operation of the wireless transmission system 20. To that end, the transmission controller 28 may be operatively associated with the memory 27. The memory may include one or more of internal memory, external memory, and/or remote memory (e.g., a database and/or server operatively connected to the transmission controller 28 via a network, such as, but not limited to, the Internet), each of which may be examples of at least one non-transitory machine-readable medium. The internal memory and/or external memory may include, but are not limited to including, one or more of a read only memory (ROM), including programmable read-only memory (PROM), erasable programmable read-only memory (EPROM or sometimes but rarely labelled EROM), electrically erasable programmable read-only memory (EEPROM), random access memory (RAM), including dynamic RAM (DRAM), static RAM (SRAM), synchronous dynamic RAM (SDRAM), single data rate synchronous dynamic RAM (SDR SDRAM), double data rate synchronous dynamic RAM (DDR SDRAM, DDR2, DDR3, DDR4), graphics double data rate synchronous dynamic RAM (GDDR SDRAM, GDDR2, GDDR3, GDDR4, GDDR5, GDDR6), a flash memory, a portable memory, and the like. Such memory media are examples of non-transitory machine-readable and/or computer-readable memory media.

While particular elements of the transmission control system 26 are illustrated as independent components and/or circuits (e.g., the driver 48, the memory 27, the communications system 29, the sensing system 50, among other contemplated elements) of the transmission control system 26, such components may be integrated with the transmission controller 28. In some examples, the transmission controller 28 may be an integrated circuit configured to include functional elements of one or more of the transmission controller 28 and/or other components of the wireless transmission system 20, generally.

Prior to providing data transmission and receipt details, it should be noted that either of the wireless transmission system 20 and the wireless receiver system 30 may send data to the other within the disclosed principles, regardless of which entity is wirelessly sending or wirelessly receiving power. As illustrated, the transmission controller 28 is in operative association, for the purposes of data transmission, receipt, and/or communication, with, at least, the memory 27, the communications system 29, the power conditioning system 40, the driver 48, and the sensing system 50. The driver 48 may be implemented to control, at least in part, the operation of the power conditioning system 40. In some examples, the driver 48 may receive instructions from the transmission controller 28 to generate and/or output a generated pulse width modulation (PWM) signal to the power conditioning system 40. In some such examples, the PWM signal may be configured to drive the power conditioning system 40 to output electrical power as an alternating current signal, having an operating frequency defined by the PWM signal. In some examples, PWM signal may be configured to generate a duty cycle for the AC power signal output by the power conditioning system 40. In some such examples, the duty cycle may be configured to be about 50% of a given period of the AC power signal; however, the duty cycle is certainly not limited to being about 50% of a given period of the AC power signal.

The sensing system may include one or more sensors, wherein each sensor may be operatively associated with one or more components of the wireless transmission system 20 and configured to provide information and/or data. The term “sensor” is used in its broadest interpretation to define one or more components operatively associated with the wireless transmission system 20 that operate to sense functions, conditions, electrical characteristics, operations, and/or operating characteristics of one or more of the wireless transmission system 20, the wireless receiving system 30, the input power source 12, the host device 11, the transmission antenna 21, the receiver antenna 31, along with any other components and/or subcomponents thereof. Again, while the examples may illustrate a certain configuration, it should be appreciated that either of the wireless transmission system 20 and the wireless receiver system 30 may send data to the other within the disclosed principles, regardless of which entity is wirelessly sending or wirelessly receiving power.

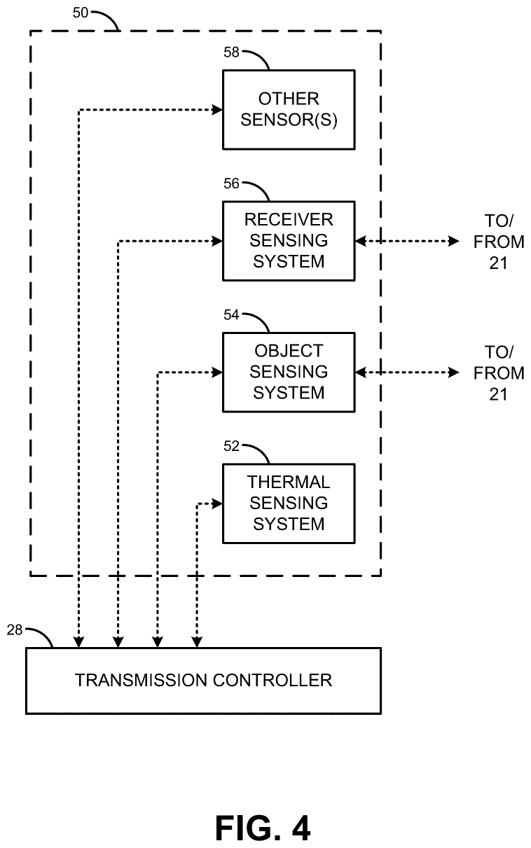

As illustrated in the embodiment of FIG. 4, the sensing system 50 may include, but is not limited to including, a thermal sensing system 52, an object sensing system 54, a receiver sensing system 56, and/or any other sensor(s) 58. Within these systems, there may exist even more specific optional additional or alternative sensing systems addressing particular sensing aspects required by an application, such as, but not limited to: a condition-based maintenance sensing system, a performance optimization sensing system, a state-of-charge sensing system, a temperature management sensing system, a component heating sensing system, an IoT sensing system, an energy and/or power management sensing system, an impact detection sensing system, an electrical status sensing system, a speed detection sensing system, a device health sensing system, among others. The object sensing system 54, may be a foreign object detection (FOD) system.

Each of the thermal sensing system 52, the object sensing system 54, the receiver sensing system 56 and/or the other sensor(s) 58, including the optional additional or alternative systems, are operatively and/or communicatively connected to the transmission controller 28. The thermal sensing system 52 is configured to monitor ambient and/or component temperatures within the wireless transmission system 20 or other elements nearby the wireless transmission system 20. The thermal sensing system 52 may be configured to detect a temperature within the wireless transmission system 20 and, if the detected temperature exceeds a threshold temperature, the transmission controller 28 prevents the wireless transmission system 20 from operating. Such a threshold temperature may be configured for safety considerations, operational considerations, efficiency considerations, and/or any combinations thereof. In a non-limiting example, if, via input from the thermal sensing system 52, the transmission controller 28 determines that the temperature within the wireless transmission system 20 has increased from an acceptable operating temperature to an undesired operating temperature (e.g., in a non-limiting example, the internal temperature increasing from about 200 Celsius (C) to about 50° C., the transmission controller 28 prevents the operation of the wireless transmission system 20 and/or reduces levels of power output from the wireless transmission system 20. In some non-limiting examples, the thermal sensing system 52 may include one or more of a thermocouple, a thermistor, a negative temperature coefficient (NTC) resistor, a resistance temperature detector (RTD), and/or any combinations thereof.

As depicted in FIG. 4, the sensing system 50 may include the object sensing system 54. The object sensing system 54 may be configured to detect one or more of the wireless receiver system 30 and/or the receiver antenna 31, thus indicating to the transmission controller 28 that the receiver system 30 is proximate to the wireless transmission system 20. Additionally or alternatively, the object sensing system 54 may be configured to detect presence of unwanted objects in contact with or proximate to the wireless transmission system 20. In some examples, the object sensing system 54 is configured to detect the presence of an undesired object. In some such examples, if the transmission controller 28, via information provided by the object sensing system 54, detects the presence of an undesired object, then the transmission controller 28 prevents or otherwise modifies operation of the wireless transmission system 20. In some examples, the object sensing system 54 utilizes an impedance change detection scheme, in which the transmission controller 28 analyzes a change in electrical impedance observed by the transmission antenna 21 against a known, acceptable electrical impedance value or range of electrical impedance values.

Additionally or alternatively, the object sensing system 54 may utilize a quality factor (Q) change detection scheme, in which the transmission controller 28 analyzes a change from a known quality factor value or range of quality factor values of the object being detected, such as the receiver antenna 31. The “quality factor” or “Q” of an inductor can be defined as (frequency (Hz)xinductance (H))/resistance (ohms), where frequency is the operational frequency of the circuit, inductance is the inductance output of the inductor and resistance is the combination of the radiative and reactive resistances that are internal to the inductor. “Quality factor,” as defined herein, is generally accepted as an index (figure of measure) that measures the efficiency of an apparatus like an antenna, a circuit, or a resonator. In some examples, the object sensing system 54 may include one or more of an optical sensor, an electro-optical sensor, a Hall effect sensor, a proximity sensor, and/or any combinations thereof.

The receiver sensing system 56 is any sensor, circuit, and/or combinations thereof configured to detect presence of any wireless receiving system that may be couplable with the wireless transmission system 20. In some examples, the receiver sensing system 56 and the object sensing system 54 may be combined, may share components, and/or may be embodied by one or more common components. In some examples, if the presence of any such wireless receiving system is detected, wireless transmission of electrical energy, electrical power, electromagnetic energy, and/or data by the wireless transmission system 20 to said wireless receiving system is enabled. In some examples, if the presence of a wireless receiver system is not detected, continued wireless transmission of electrical energy, electrical power, electromagnetic energy, and/or data is prevented from occurring. Accordingly, the receiver sensing system 56 may include one or more sensors and/or may be operatively associated with one or more sensors that are configured to analyze electrical characteristics within an environment of or proximate to the wireless transmission system 20 and, based on the electrical characteristics, determine presence of a wireless receiver system 30.

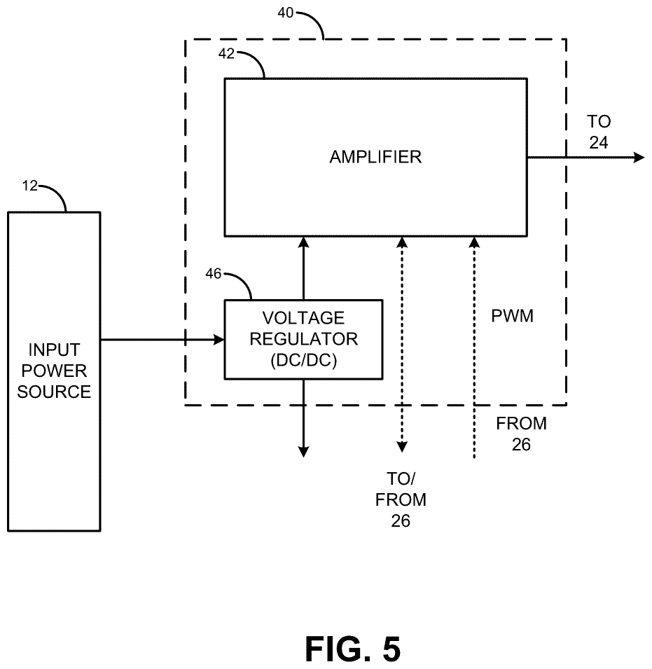

Referring now to FIG. 5, and with continued reference to FIGS. 1-4, a block diagram illustrating an embodiment of the power conditioning system 40 is illustrated. At the power conditioning system 40, electrical power is received, generally, as a DC power source, via the input power source 12 itself or an intervening power converter, converting an AC source to a DC source (not shown). A voltage regulator 46 receives the electrical power from the input power source 12 and is configured to provide electrical power for transmission by the transmission antenna 21 and provide electrical power for powering components of the wireless transmission system 20. Accordingly, the voltage regulator 46 is configured to convert the received electrical power into at least two electrical power signals, each at a proper voltage for operation of the respective downstream components: a first electrical power signal to electrically power any components of the wireless transmission system 20 and a second portion conditioned and modified for wireless transmission to the wireless receiver system 30. As illustrated in FIG. 3, such a first portion is transmitted to, at least, the sensing system 50, the transmission controller 28, and the communications system 29; however, the first portion is not limited to transmission to just these components and can be transmitted to any electrical components of the wireless transmission system 20.

The second portion of the electrical power is provided to an amplifier 42 of the power conditioning system 40, which is configured to condition the electrical power for wireless transmission by the transmission antenna 21. The amplifier may function as an inverter, which receives an input DC power signal from the voltage regulator 46 and generates an AC signal as output, based, at least in part, on PWM input from the transmission control system 26. The amplifier 42 may be or include, for example, a power stage invertor, such as a dual field effect transistor power stage invertor or a quadruple field effect transistor power stage invertor. The use of the amplifier 42 within the power conditioning system 40 and, in turn, the wireless transmission system 20 enables wireless transmission of electrical signals having much greater amplitudes than if transmitted without such an amplifier. For example, the addition of the amplifier 42 may enable the wireless transmission system 20 to transmit electrical energy as an electrical power signal having electrical power from about 10 mW to about 500 W. In some examples, the amplifier 42 may be or may include one or more class-E power amplifiers. Class-E power amplifiers are efficiently tuned switching power amplifiers designed for use at high frequencies (e.g., frequencies from about 1 MHz to about 1 GHz). Generally, a class-E amplifier employs a single-pole switching element and a tuned reactive network between the switch and an output load (e.g., the transmission antenna 21). Class E amplifiers may achieve high efficiency at high frequencies by only operating the switching element at points of zero current (e.g., on-to-off switching) or zero voltage (off to on switching). Such switching characteristics may minimize power lost in the switch, even when the switching time of the device is long compared to the frequency of operation. However, the amplifier 42 is certainly not limited to being a class-E power amplifier and may be or may include one or more of a class D amplifier, a class EF amplifier, an H invertor amplifier, and/or a push-pull invertor, among other amplifiers that could be included as part of the amplifier 42.

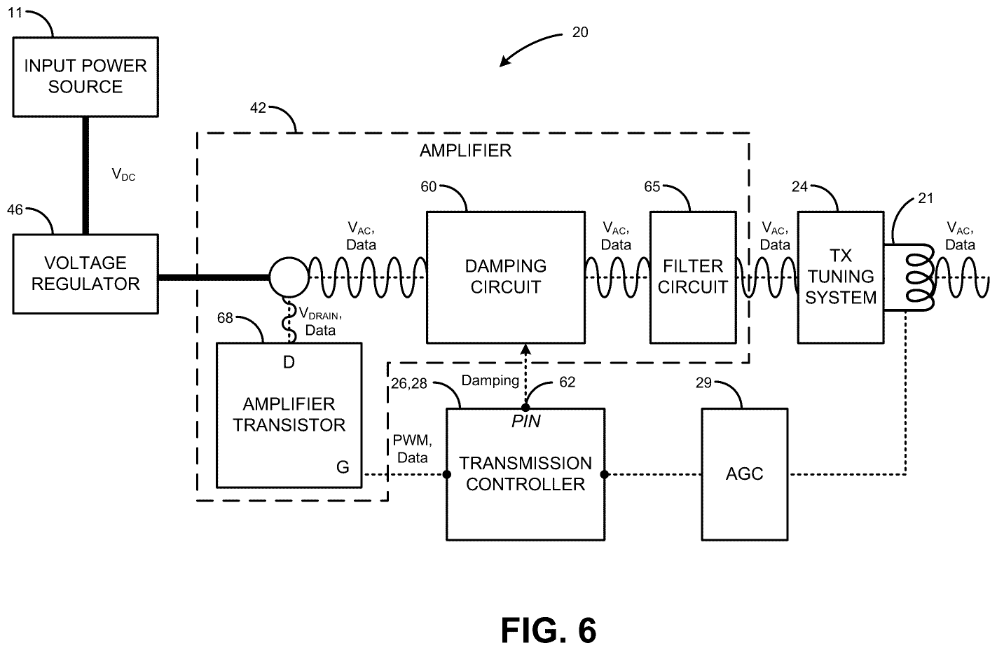

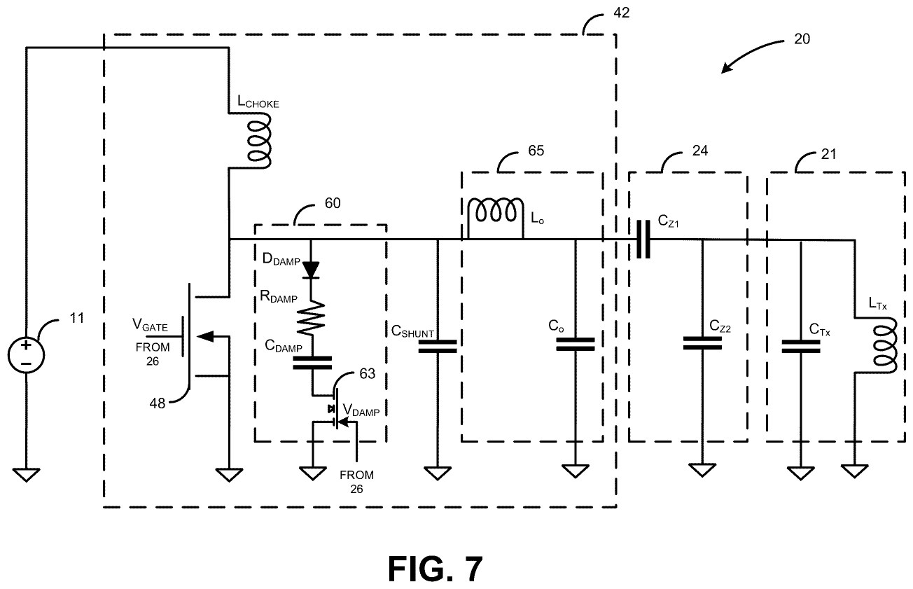

Turning now to FIGS. 6 and 7, the wireless transmission system 20 is illustrated, further detailing elements of the power conditioning system 40, the amplifier 42, and the transmission tuning system 24, among other things. The block diagram of the wireless transmission system 20 illustrates one or more electrical signals and the conditioning of such signals, altering of such signals, transforming of such signals, inverting of such signals, amplification of such signals, and combinations thereof. In FIG. 6, DC power signals are illustrated with heavily bolded lines, such that the lines are significantly thicker than other solid lines in FIG. 6 and other figures of the instant application, AC signals are illustrated as substantially sinusoidal wave forms with a thickness significantly less bolded than that of the DC power signal bolding, and data signals are represented as dotted lines. It is to be noted that the AC signals are not necessarily substantially sinusoidal waves and may be any AC waveform suitable for the purposes described below (e.g., a half sine wave, a square wave, a half square wave, among other waveforms). FIG. 7 illustrates sample electrical components for elements of the wireless transmission system, and subcomponents thereof, in a simplified form. Note that FIG. 7 may represent one branch or sub-section of a schematic for the wireless transmission system 20 and/or components of the wireless transmission system 20 may be omitted from the schematic illustrated in FIG. 7 for clarity.

As illustrated in FIG. 6 and discussed above, the input power source 12 provides an input direct current voltage (V_{DC}), which may have its voltage level altered by the voltage regulator 46, prior to conditioning at the amplifier 42. In some examples, as illustrated in FIG. 7, the amplifier 42 may include a choke inductor L_{CHOKE}, which may be utilized to block radio frequency interference in V_{DC}, while allowing the DC power signal of V_{DC} to continue towards an amplifier transistor 68 of the amplifier 42. V_{CHOKE} may be configured as any suitable choke inductor known in the art.

The amplifier 42 is configured to alter and/or invert V_{DC} to generate an AC wireless signal V_{AC}, which, as discussed in more detail below, may be configured to carry one or both of an inbound and outbound data signal (denoted as “Data” in FIG. 6). The amplifier transistor 48 may be any switching transistor known in the art that is capable of inverting, converting, and/or conditioning a DC power signal into an AC power signal, such as, but not limited to, a field-effect transistor (FET), gallium nitride (GaN) FETS, bipolar junction transistor (BJT), and/or wide-bandgap (WBG) semiconductor transistor, among other known switching transistors. The amplifier transistor 68 is configured to receive a driving signal (denoted as “PWM” in FIG. 6) from at a gate of the amplifier transistor 68 (denoted as “G” in FIG. 6) and invert the DC signal V_{DC} to generate the AC wireless signal at an operating frequency and/or an operating frequency band for the wireless transmission system 20. The driving signal may be a PWM signal configured for such inversion at the operating frequency and/or operating frequency band for the wireless transmission system 20.

The driving signal is generated and output by the transmission control system 26 and/or the transmission controller 28 therein, as discussed and disclosed above. The transmission controller 28 is configured to provide the driving signal and configured to perform one or more of encoding wireless data signals (denoted as “Data” in FIG. 6), decoding the wireless data signals (denoted as “Data” in FIG. 6) and any combinations thereof. In some examples, the electrical data signals may be in band signals of the AC wireless power signal. In some such examples, such in-band signals may be on-off-keying (OOK) signals in-band of the AC wireless power signals. For example, Type-A communications, as described in the NFC Standards, are a form of OOK, wherein the data signal is on-off-keyed in a carrier AC wireless power signal operating at an operating frequency in a range of about 13.553 MHz to about 13.567 MHz.

However, when the power, current, impedance, phase, and/or voltage levels of an AC power signal are changed beyond the levels used in current and/or legacy hardware for high frequency wireless power transfer (over about 500 mW transmitted), such legacy hardware may not be able to properly encode and/or decode in-band data signals with the required fidelity for communications functions. Such higher power in an AC output power signal may cause signal degradation due to increasing rise times for an OOK rise, increasing fall time for an OOK fall, overshooting the required voltage in an OOK rise, and/or undershooting the voltage in an OOK fall, among other potential degradations to the signal due to legacy hardware being ill equipped for higher power, high frequency wireless power transfer. Thus, there is a need for the amplifier 42 to be designed in a way that limits and/or substantially removes rise and fall times, overshoots, undershoots, and/or other signal deficiencies from an in-band data signal during wireless power transfer. This ability to limit and/or substantially remove such deficiencies allows for the systems of the instant application to provide higher power wireless power transfer in high frequency wireless power transmission systems.

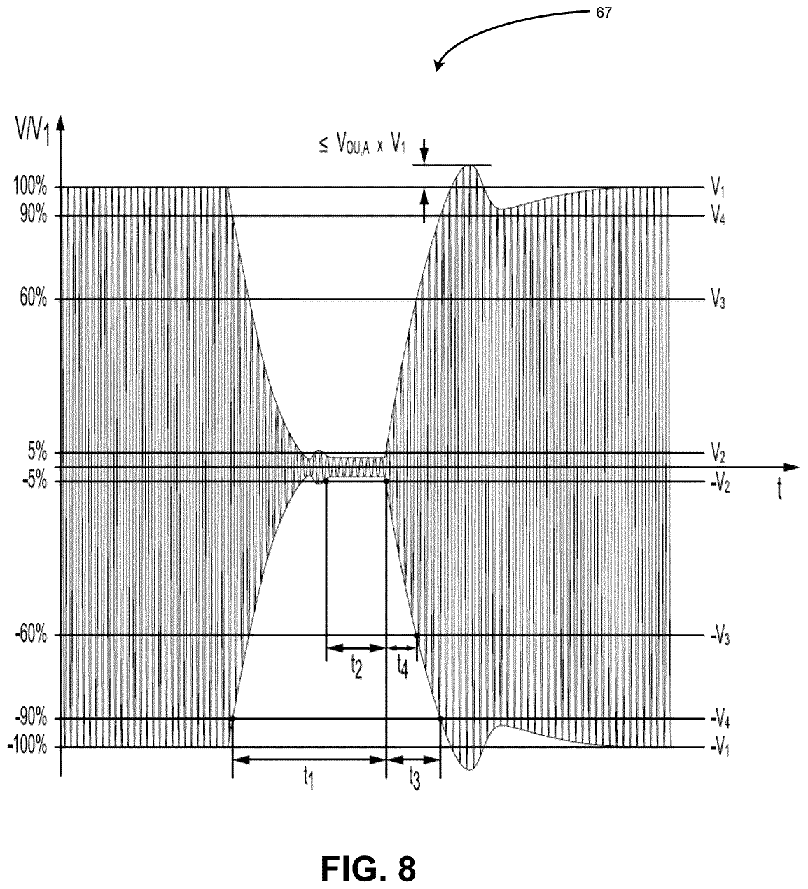

For further exemplary illustration, FIG. 8 illustrates a plot 67 for a fall and rise of an OOK in-band signal. The fall time (ti) is shown as the time between when the signal is at 90% voltage (V₄) of the intended full voltage (V₁) and falls to about 5% voltage (V₂) of V₁. The rise time (t) is shown as the time between when the signal ends being at V₂ and rises to about V₄. Such rise and fall times may be read by a receiving antenna of the signal, and an applicable data communications protocol may include limits on rise and fall times, such that data is non-compliant and/or illegible by a receiver if rise and/or fall times exceed certain bounds.

Returning now to FIGS. 6 and 7, to achieve limitation and/or substantial removal of the mentioned deficiencies, the amplifier 42 includes a damping circuit 60. The damping circuit 60 is configured for damping the AC wireless signal during transmission of the AC wireless signal and associated data signals. The damping circuit 60 may be configured to reduce rise and fall times during OOK signal transmission, such that the rate of the data signals may not only be compliant and/or legible, but may also achieve faster data rates and/or enhanced data ranges, when compared to legacy systems. For damping the AC wireless power signal, the damping circuit includes, at least, a damping transistor 63, which is configured for receiving a damping signal (V_{damp}) from the transmission controller 28. The damping signal is configured for switching the damping transistor (on/off) to control damping of the AC wireless signal during the transmission and/or receipt of wireless data signals. Such transmission of the AC wireless signals may be performed by the transmission controller 28 and/or such transmission may be via transmission from the wireless receiver system 30, within the coupled magnetic field between the antennas 21, 31.

In examples wherein the data signals are conveyed via OOK, the damping signal may be substantially opposite and/or an inverse to the state of the data signals. This means that if the OOK data signals are in an “on” state, the damping signals instruct the damping transistor to turn “off” and thus the signal is not dissipated via the damping circuit 60 because the damping circuit is not set to ground and, thus, a short from the amplifier circuit and the current substantially bypasses the damping circuit 60. If the OOK data signals are in an “off” state, then the damping signals may be “on” and, thus, the damping transistor 63 is set to an “on” state and the current flowing of VAC is damped by the damping circuit. Thus, when “on,” the damping circuit 60 may be configured to dissipate just enough power, current, and/or voltage, such that efficiency in the system is not substantially affected and such dissipation decreases rise and/or fall times in the OOK signal. Further, because the damping signal may instruct the damping transistor 63 to turn “off” when the OOK signal is “on,” then it will not unnecessarily damp the signal, thus mitigating any efficiency losses from VAC, when damping is not needed. While depicted as utilizing OOK coding, other forms of in band coding may be utilized for coding the data signals, such as, but not limited to, amplitude shift keying (ASK).

As illustrated in FIG. 7, the branch of the amplifier 42 which may include the damping circuit 60, is positioned at the output drain of the amplifier transistor 68. While it is not necessary that the damping circuit 60 be positioned here, in some examples, this may aid in properly damping the output AC wireless signal, as it will be able to damp at the node closest to the amplifier transistor 68 output drain, which is the first node in the circuit wherein energy dissipation is desired. In such examples, the damping circuit is in electrical parallel connection with a drain of the amplifier transistor 68. However, it is certainly possible that the damping circuit be connected proximate to the transmission antenna 21, proximate to the transmission tuning system 24, and/or proximate to a filter circuit 65.

While the damping circuit 60 is capable of functioning to properly damp the AC wireless signal for proper communications at higher power high frequency wireless power transmission, in some examples, the damping circuit may include additional components. For instance, as illustrated, the damping circuit 60 may include one or more of a damping diode D_{DAMP}, a damping resistor R_{DAMP}, a damping capacitor C_{DAMP}, and/or any combinations thereof. R_{DAMP} may be in electrical series with the damping transistor 63 and the value of R_{DAMP} (ohms) may be configured such that it dissipates at least some power from the power signal, which may serve to accelerate rise and fall times in an amplitude shift keying signal, an OOK signal, and/or combinations thereof. In some examples, the value of R_{DAMP} is selected, configured, and/or designed such that R_{DAMP} dissipates the minimum amount of power to achieve the fastest rise and/or fall times in an in-band signal allowable and/or satisfy standards limitations for minimum rise and/or fall times; thereby achieving data fidelity at maximum efficiency (less power lost to R_{DAMP}) as well as maintaining data fidelity when the system is unloaded and/or under lightest load conditions.

C_{DAMP} may also be in series connection with one or both of the damping transistor 63 and R_{DAMP}. C_{DA}MP may be configured to smooth out transition points in an in-band signal and limit overshoot and/or undershoot conditions in such a signal. Further, in some examples, C_{DAMP} may be configured for ensuring the damping performed is 180 degrees out of phase with the AC wireless power signal, when the transistor is activated via the damping signal.

D_{DAMP} may further be included in series with one or more of the damping transistor 63, R_{DAMP}, C_{DAMP}, and/or any combinations thereof. D_{DAMP} is positioned, as shown, such that a current cannot flow out of the damping circuit 60, when the damping transistor 63 is in an off state. The inclusion of D_{DA}MP may prevent power efficiency loss in the AC power signal when the damping circuit is not active or “on.” Indeed, while the damping transistor 63 is designed such that, in an ideal scenario, it serves to effectively short the damping circuit when in an “off” state, in practical terms, some current may still reach the damping circuit and/or some current may possibly flow in the opposite direction out of the damping circuit 60. Thus, inclusion of D_{DAMP} may prevent such scenarios and only allow current, power, and/or voltage to be dissipated towards the damping transistor 63. This configuration, including D_{DA}MP, may be desirable when the damping circuit 60 is connected at the drain node of the amplifier transistor 68, as the signal may be a half-wave sine wave voltage and, thus, the voltage of V_{A}C is always positive.

Beyond the damping circuit 60, the amplifier 42, in some examples, may include a shunt capacitor C_{SHUNT}. C_{SHUNT} may be configured to shunt the AC power signal to ground and charge voltage of the AC power signal. Thus, C_{SHUNT} may be configured to maintain an efficient and stable waveform for the AC power signal, such that a duty cycle of about 50% is maintained and/or such that the shape of the AC power signal is substantially sinusoidal at positive voltages.

In some examples, the amplifier 42 may include a filter circuit 65. The filter circuit 65 may be designed to mitigate and/or filter out electromagnetic interference (EMI) within the wireless transmission system 20. Design of the filter circuit 65 may be performed in view of impedance transfer and/or effects on the impedance transfer of the wireless power transmission 20 due to alterations in tuning made by the transmission tuning system 24. To that end, the filter circuit 65 may be or include one or more of a low pass filter, a high pass filter, and/or a band pass filter, among other filter circuits that are configured for, at least, mitigating EMI in a wireless power transmission system.

As illustrated, the filter circuit 65 may include a filter inductor Lₒ and a filter capacitor Co. The filter circuit 65 may have a complex impedance and, thus, a resistance through the filter circuit 65 may be defined as Ro. In some such examples, the filter circuit 65 may be designed and/or configured for optimization based on, at least, a filter quality factor γ_{FILTER}, defined as:

$${γ}_{FILTER} = \frac{1}{{R}_{o}} \sqrt{\frac{{L}_{o}}{{C}_{o}}} .$$

In a filter circuit 65 wherein it includes or is embodied by a low pass filter, the cut-off frequency (ωₒ) of the low pass filter is defined as:

$${ω}_{o} = \frac{1}{\sqrt{{L}_{o} {C}_{o}}} .$$

In some wireless power transmission systems 20, it is desired that the cutoff frequency be about 1.03-1.4 times greater than the operating frequency of the antenna. Experimental results have determined that, in general, a larger γ_{FILTER} may be preferred, because the larger γ_{FILTER} can improve voltage gain and improve system voltage ripple and timing. Thus, the above values for Lₒ and Cₒ may be set such that γ_{FILTER} can be optimized to its highest, ideal level (e.g., when the system 10 impedance is conjugately matched for maximum power transfer), given cutoff frequency restraints and available components for the values of Lₒ and Cₒ.

As illustrated in FIG. 7, the conditioned signal(s) from the amplifier 42 is then received by the transmission tuning system 24, prior to transmission by the transmission antenna 21. The transmission tuning system 24 may include tuning and/or impedance matching, filters (e.g. a low pass filter, a high pass filter, a “pi” or “IT” filter, a “T” filter, an “L” filter, a “LL” filter, and/or an L-C trap filter, among other filters), network matching, sensing, and/or conditioning elements configured to optimize wireless transfer of signals from the wireless transmission system 20 to the wireless receiver system 30. Further, the transmission tuning system 24 may include an impedance matching circuit, which is designed to match impedance with a corresponding wireless receiver system 30 for given power, current, and/or voltage requirements for wireless transmission of one or more of electrical energy, electrical power, electromagnetic energy, and electronic data. The illustrated transmission tuning system 24 includes, at least, C_{Z1}, C_{Z2}. and (operatively associated with the transmission antenna 21) values, all of which may be configured for impedance matching in one or both of the wireless transmission system 20 and the broader system 10. It is noted that C_{Tx} refers to the intrinsic capacitance of the transmission antenna 21.

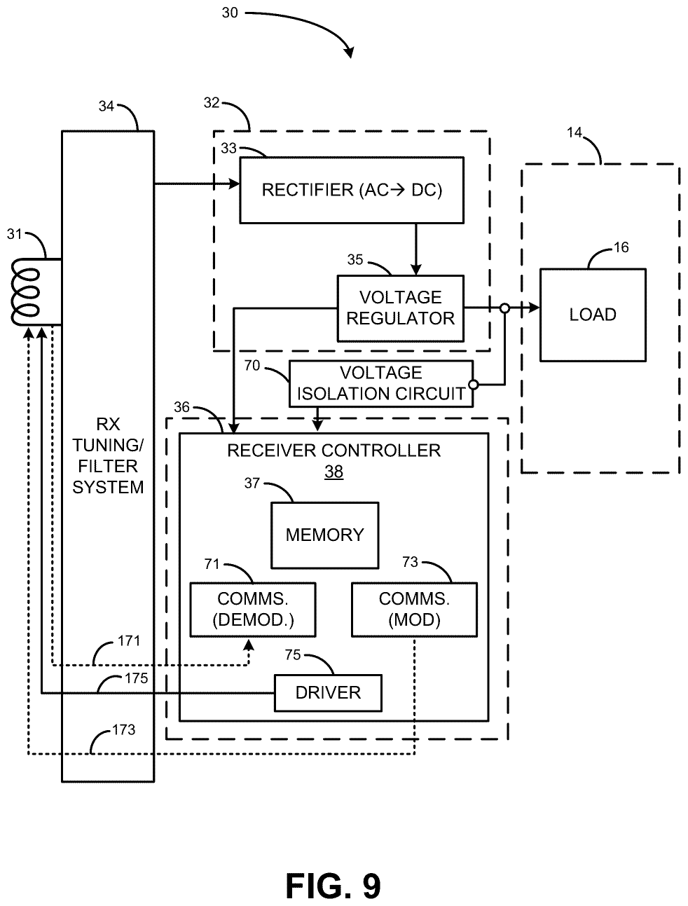

Turning now to FIG. 9 and with continued reference to, at least, FIGS. 1 and 2, the wireless receiver system 30 is illustrated in further detail. The wireless receiver system 30 is configured to receive, at least, electrical energy, electrical power, electromagnetic energy, and/or electrically transmittable data via near field magnetic coupling from the wireless transmission system 20, via the transmission antenna 21. As illustrated in FIG. 9, the wireless receiver system 30 includes, at least, the receiver antenna 31, a receiver tuning system 34, a power conditioning system 32, a receiver control system 36, and a voltage isolation circuit 70. The receiver tuning system 34 may be configured to substantially match the electrical impedance of the wireless transmission system 20. In some examples, the receiver tuning system 34 may be configured to dynamically adjust and substantially match the electrical impedance of the receiver antenna 31 to a characteristic impedance of the power generator or the load at a driving frequency of the transmission antenna 21.

As illustrated, the power conditioning system 32 includes a rectifier 33 and a voltage regulator 35. In some examples, the rectifier 33 is in electrical connection with the receiver tuning system 34. The rectifier 33 is configured to convert the received electrical energy from an alternating current electrical energy signal to a direct current electrical energy signal. In some examples, the rectifier 33 is comprised of at least one diode. Some non-limiting example configurations for the rectifier 33 include, but are not limited to including, a full wave rectifier, a center tapped full wave rectifier, a full wave rectifier with filter, a half wave rectifier, a half wave rectifier with filter, a bridge rectifier, a bridge rectifier with filter, a split supply rectifier, a single phase rectifier, a three phase rectifier, a voltage doubler, a synchronous voltage rectifier, a controlled rectifier, an uncontrolled rectifier, a half controlled rectifier, and the like. As electronic devices may be sensitive to voltage, additional protection of the electronic device may be provided by clipper circuits or devices. In this respect, the rectifier 33 may further include a clipper circuit or a clipper device, which is a circuit or device that removes either the positive half (top half), the negative half (bottom half), or both the positive and the negative halves of an input AC signal. In other words, a clipper is a circuit or device that limits the positive amplitude, the negative amplitude, or both the positive and the negative amplitudes of the input AC signal.

Some non-limiting examples of a voltage regulator 35 include, but are not limited to, including a series linear voltage regulator, a buck convertor, a low dropout (LDO) regulator, a shunt linear voltage regulator, a step up switching voltage regulator, a step down switching voltage regulator, an invertor voltage regulator, a Zener controlled transistor series voltage regulator, a charge pump regulator, and an emitter follower voltage regulator. The voltage regulator 35 may further include a voltage multiplier, which is as an electronic circuit or device that delivers an output voltage having an amplitude (peak value) that is, for example, two, three, or more times greater than the amplitude (peak value) of the input voltage. The voltage regulator 35 is in electrical connection with the rectifier 33 and configured to adjust the amplitude of the electrical voltage of the wirelessly received electrical energy signal, after conversion to AC by the rectifier 33. In some examples, the voltage regulator 35 may a LDO linear voltage regulator; however, other voltage regulation circuits and/or systems are contemplated. As illustrated, the direct current electrical energy signal output by the voltage regulator 35 is received at the load 16 of the electronic device 14. In some examples, a portion of the direct current electrical power signal may be utilized to power the receiver control system 36 and any components thereof; however, it is certainly possible that the receiver control system 36, and any components thereof, may be powered and/or receive signals from the load 16 (e.g., when the load 16 is a battery and/or other power source) and/or other components of the electronic device 14.

The receiver control system 36 may include, but is not limited to including, a receiver controller 38, a communications system 39 and a memory 37. The receiver controller 38 may be any electronic controller or computing system that includes, at least, a processor which performs operations, executes control algorithms, stores data, retrieves data, gathers data, controls and/or provides communication with other components and/or subsystems associated with the wireless receiver system 30. The receiver controller 38 may be a single controller or may include more than one controller disposed to control various functions and/or features of the wireless receiver system 30. Functionality of the receiver controller 38 may be implemented in hardware and/or software and may rely on one or more data maps relating to the operation of the wireless receiver system 30. To that end, the receiver controller 38 may be operatively associated with the memory 37. The memory may include one or both of internal memory, external memory, and/or remote memory (e.g., a database and/or server operatively connected to the receiver controller 38 via a network, such as, but not limited to, the Internet). The internal memory and/or external memory may include, but are not limited to including, one or more of a read only memory (ROM), including programmable read-only memory (PROM), erasable programmable read-only memory (EPROM or sometimes but rarely labelled EROM), electrically erasable programmable read-only memory (EEPROM), random access memory (RAM), including dynamic RAM (DRAM), static RAM (SRAM), synchronous dynamic RAM (SDRAM), single data rate synchronous dynamic RAM (SDR SDRAM), double data rate synchronous dynamic RAM (DDR SDRAM, DDR2, DDR3, DDR4), and graphics double data rate synchronous dynamic RAM (GDDR SDRAM, GDDR2, GDDR3, GDDR4, GDDR5, a flash memory, a portable memory, and the like. Such memory media are examples of non-transitory computer and/or machine readable memory media.

Further, while particular elements of the receiver control system 36 are illustrated as subcomponents and/or circuits (e.g., the memory 37, the communications system 39, among other contemplated elements) of the receiver control system 36, such components may be external of the receiver controller 38. In some examples, the receiver controller 38 may be and/or include one or more integrated circuits configured to include functional elements of one or both of the receiver controller 38 and the wireless receiver system 30, generally. As used herein, the term “integrated circuits” generally refers to a circuit in which all or some of the circuit elements are inseparably associated and electrically interconnected so that it is considered to be indivisible for the purposes of construction and commerce. Such integrated circuits may include, but are not limited to including, thin-film transistors, thick-film technologies, and/or hybrid integrated circuits.

In some examples, the receiver controller 38 may be a dedicated circuit configured to send and receive data at a given operating frequency. For example, the receiver controller 38 may be a tagging or identifier integrated circuit, such as, but not limited to, an NFC tag and/or labelling integrated circuit. Examples of such NFC tags and/or labelling integrated circuits include the NTAG® family of integrated circuits manufactured by NXP Semiconductors N.V. However, the communications system 39 is certainly not limited to these example components and, in some examples, the communications system 39 may be implemented with another integrated circuit (e.g., integrated with the receiver controller 38), and/or may be another transceiver of or operatively associated with one or both of the electronic device 14 and the wireless receiver system 30, among other contemplated communication systems and/or apparatus. Further, in some examples, functions of the communications system 39 may be integrated with the receiver controller 38, such that the controller modifies the inductive field between the antennas 21, 31 to communicate in the frequency band of wireless power transfer operating frequency.

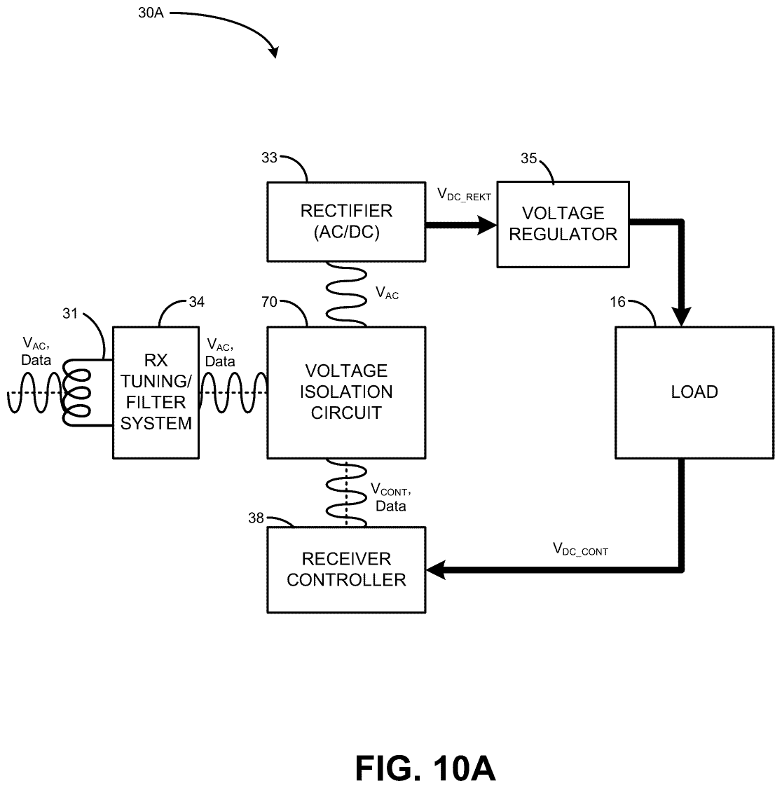

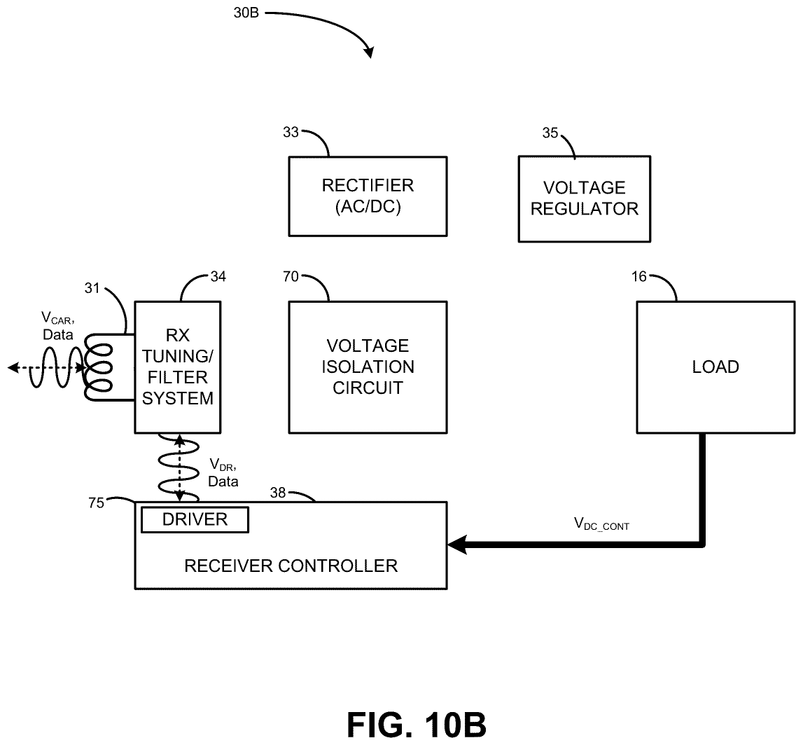

Turning now to FIGS. 10A and 10B, the wireless receiver system 30 is illustrated in further detail to show some example functionality of one or more of the receiver controller 38, the voltage isolation circuit 70, and the rectifier 33. The block diagram of the wireless receiver system 30 illustrates one or more electrical signals and the conditioning of such signals, altering of such signals, transforming of such signals, rectifying of such signals, amplification of such signals, and combinations thereof. Similarly to FIG. 6, DC power signals are illustrated with heavily bolded lines, such that the lines are significantly thicker than other solid lines in FIG. 6 and other figures of the instant application, AC signals are illustrated as substantially sinusoidal wave forms with a thickness significantly less bolded than that of the DC power signal bolding, and data signals are represented as dotted lines.

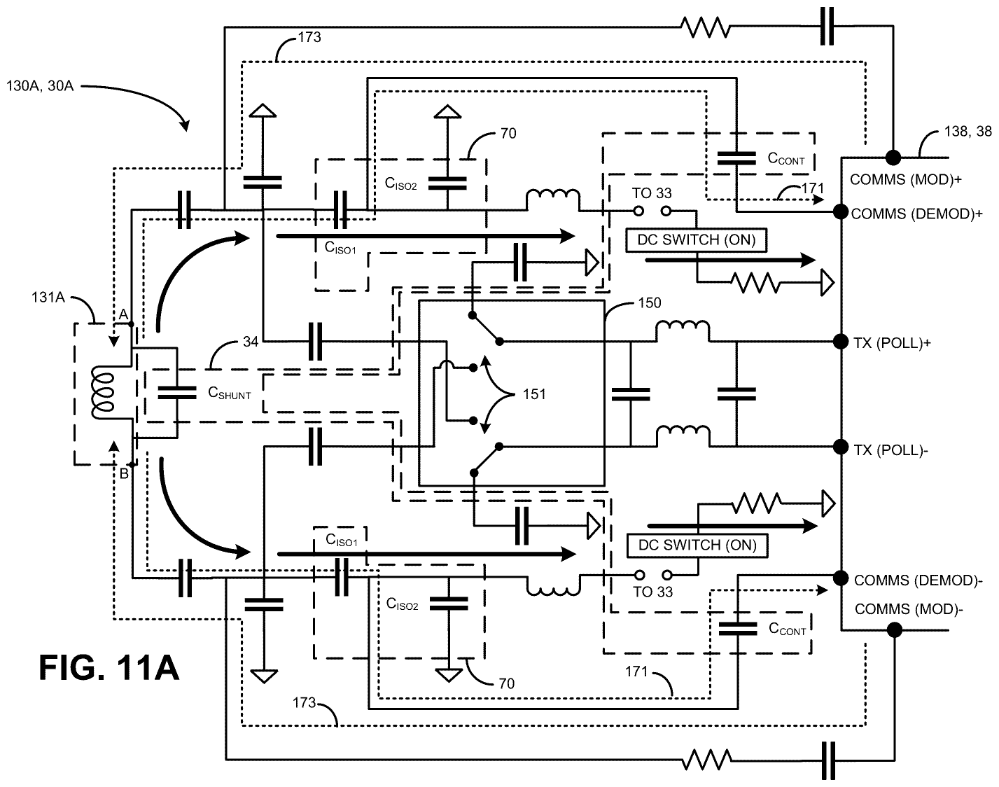

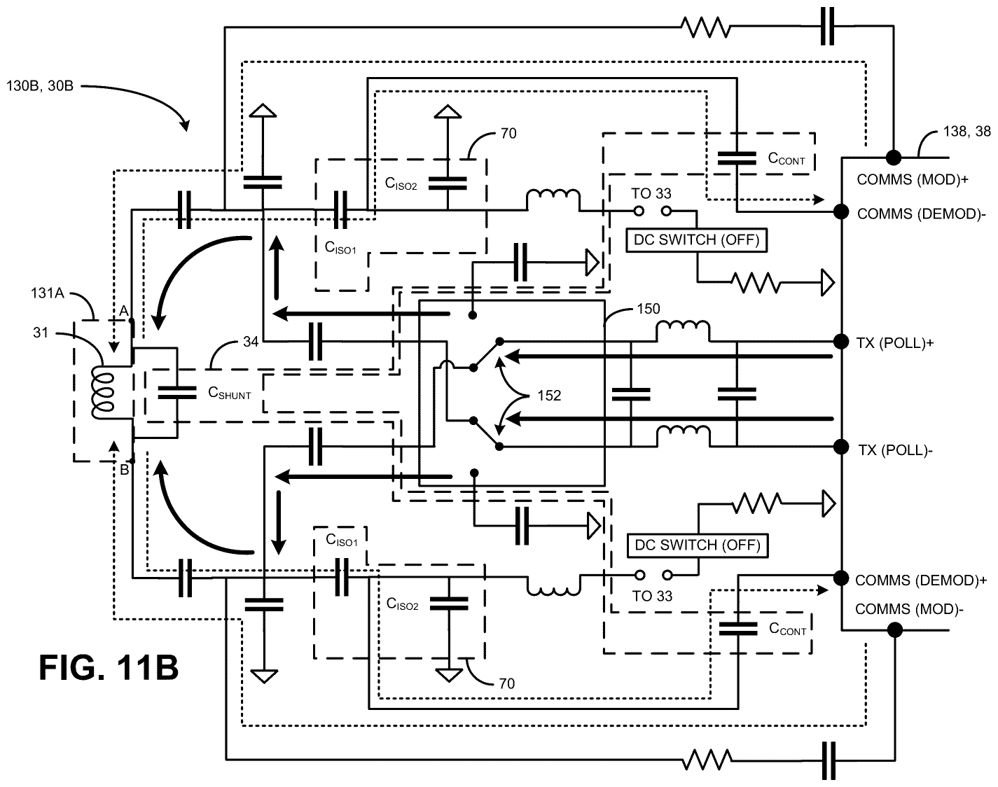

FIGS. 11A and 11B illustrate sample electrical components for elements of the wireless receiver system, and subcomponents thereof, in a simplified form. Note that FIGS. 11A, 11B may represent one or subsection of a schematic for the wireless receiver system 30 and/or components of the wireless receiver system 30 may be omitted from the schematic, illustrated in FIGS. 11, for clarity.

As illustrated in FIG. 10A, the receiver antenna 31 receives the AC wireless signal, which includes the AC power signal (V_{AC}) and the data signals (denoted as “Data” in FIG. 10A), from the transmission antenna 21 of the wireless transmission system 20. (It should be understood an example of a transmitted AC power signal and data signal was previously shown in FIG. 6). V_{AC} will be received at the rectifier 33 and/or the broader power conditioning system 32, wherein the AC wireless power signal is converted to a DC wireless power signal (V_{DC_REKT}). V_{DC_REKT} is then provided to, at least, the load 16 that is operatively associated with the wireless receiver system 30. In some examples, V_{DC_REKT} is regulated by the voltage regulator 35 and provided as a DC input voltage (V_{DC_CONT}) for the receiver controller 38. In some examples, such as the signal path shown in FIGS. 10A, 11A, the receiver controller 38 may be directly powered by the load 16. In some other examples, the receiver controller 38 need not be powered by the load 16 and/or receipt of V_{DC_CONT}, but the receiver controller 38 may harness, capture, and/or store power from V_{AC}, as power receipt occurring in receiving, decoding, and/or otherwise detecting the data signals in-band of V_{AC}.

As illustrated in FIGS. 10A, 11A, the receiver controller 38 is configured to perform one or more of encoding the wireless data signals, decoding the wireless data signals, receiving the wireless data signals, transmitting the wireless data signals, and/or any combinations thereof. In examples wherein the data signals are encoded and/or decoded as amplitude shift keyed (ASK) signals and/or OOK signals, the receiver controller 38 may receive and/or otherwise detect or monitor voltage levels of V_{AC} to detect in-band ASK and/or OOK signals. However, at higher power levels than those currently utilized in standard high frequency, NFMI communications and/or low power wireless power transmission, large voltages and/or large voltage swings at the input of a controller, such as the controller 38, may be too large for legacy microprocessor controllers to handle without disfunction or damage being done to such microcontrollers. Additionally, certain microcontrollers may only be operable at certain operating voltage ranges and, thus, when high frequency wireless power transfer occurs, the voltage swings at the input to such microcontrollers may be out of range or too wide of a range for consistent operation of the microcontroller.

For example, in some high frequency higher power wireless power transfer systems 10, when an output power from the wireless transmission system 20 is greater than 1 W, voltage across the controller 38 may be higher than desired for the controller 38. Higher voltage, lower current configurations are often desirable, as such configurations may generate lower thermal losses and/or lower generated heat in the system 10, in comparison to a high current, low voltage transmission. To that end, the load 16 may not be a consistent load, meaning that the resistance and/or impedance at the load 16 may swing drastically during, before, and/or after an instance of wireless power transfer.

This is particularly an issue when the load 16 is a battery or other power storing device, as a fully charged battery has a much higher resistance than a fully depleted battery. For the purposes of this illustrative discussion, we will assume:

$${V}_{AC \_ MIN} = {I}_{AC \_ MIN} * {R}_{LOAD \_ MIN} , and \\ {P}_{AC \_ MIN} = {I}_{AC} * {V}_{LOAD \_ MIN} = {( {I}_{AC \_ MIN} )}^{2} * {R}_{LOAD \_ MIN}$$

wherein R_{LOAD_MIN} is the minimum resistance of the load 16 (e.g., if the load 16 is or includes a battery, when the battery of the load 16 is depleted), I_{AC_MIN} is the current at R_{LOAD_MIN}, V_{AC}_MIN is the voltage of V_{AC} when the load 16 is at its minimum resistance and P_{AC_MIN} is the optimal power level for the load 16 at its minimal resistance. Further, we will assume:

$${V}_{AC \_ MAX} = {I}_{AC \_ MAX} * {R}_{LOAD \_ MAX} , and \\ {P}_{AC \_ MAX} = {I}_{AC \_ MAX} * {V}_{LOAD \_ MAX} = {( {I}_{AC \_ MAX} )}^{2} * {R}_{LOAD \_ MAX}$$

wherein R_{LOAD_MAX} is the maximum resistance of the load 16 (e.g., if the load 16 is or includes a battery, when the battery of the load 16 is depleted), I_{AC_MAX} is the current at V_{AC_MAX}, V_{AC_MAX} is the voltage of V_{AC} when the load 16 is at its minimum resistance and P_{AC_MAX} is the optimal power level for the load 16 at its maximal resistance.

Accordingly, as the current is desired to stay relatively low, the inverse relationship between I_{AC} and V_{AC} dictate that the voltage range must naturally shift, in higher ranges, with the change of resistance at the load 16.

However, such voltage shifts may be unacceptable for proper function of the controller 38. To mitigate these issues, the voltage isolation circuit 70 is included to isolate the range of voltages that can be seen at a data input and/or output of the controller 38 to an isolated controller voltage (V_{CONT}), which is a scaled version of V_{AC} and, thus, comparably scales any voltage-based in-band data input and/or output at the controller 38. Accordingly, if a range for the AC wireless signal that is an acceptable input range for the controller 38 is represented by

$${V}_{AC} = [ {V}_{AC \_ MIN} : {V}_{AC \_ MAX} ]$$

then the voltage isolation circuit 70 is configured to isolate the controller-unacceptable voltage range from the controller 38, by setting an impedance transformation to minimize the voltage swing and provide the controller with a scaled version of V_{AC}, which does not substantially alter the data signal at receipt. Such a scaled controller voltage, based on V_{AC}, is VCONT, where

$${V}_{CONT} = [ {V}_{CONT \_ MIN} : {V}_{CONT \_ MAX} ] .$$

While an altering load is one possible reason that an unacceptable voltage swing may occur at a data input of a controller, there may be other physical, electrical, and/or mechanical characteristics and/or phenomena that may affect voltage swings in V_{AC}, such as, but not limited to, changes in coupling (k) between the antennas 21, 31, detuning of the system(s) 10, 20, 30 due to foreign objects, proximity of another receiver system 30 within a common field area, among other things.

As best illustrated in FIG. 11A, the voltage isolation circuit 70 includes at least two capacitors, a first isolation capacitor C_{ISO1} and a second isolation capacitor C_{ISO2}. While only two series, split capacitors are illustrated in FIG. 11A, it should also be understood that the voltage isolation circuit may include additional pairs of split series capacitors. C_{ISO1} and C_{ISO2} are electrically in series with one another, with a node therebetween, the node providing a connection to the data input of the receiver controller 38. C_{ISO1} and C_{ISO2} are configured to regulate V_{AC} to generate the acceptable voltage input range V_{CONT} for input to the controller. Thus, the voltage isolation circuit 70 is configured to isolate the controller 38 from V_{AC}, which is a load voltage, if one considers the rectifier 33 to be part of a downstream load from the receiver controller 38.

In some examples, the capacitance values are configured such that a parallel combination of all capacitors of the voltage isolation circuit 70 (e.g. C_{ISO1} and C_{ISO2}) is equal to a total capacitance for the voltage isolation circuit (C_{TOTAL}). Thus,

$${C}_{ISO 11} ‖ {C}_{ISO 2} = {C}_{TOTAL} ,$$

wherein C_{TOTAL} is a constant capacitance configured for the acceptable voltage input range for input to the controller. C_{TOTAL} can be determined by experimentation and/or can be configured via mathematical derivation for a particular microcontroller embodying the receiver controller 38.

In some examples, with a constant C_{TOTAL}, individual values for the isolation capacitors C_{ISO1} and C_{ISO2} may be configured in accordance with the following relationships:

$${C}_{ISO 1} = \frac{{C}_{TOTAL} * ( 1 + {t}_{v} )}{{t}_{v}} , and \\ {C}_{ISO 2} = {C}_{TOTAL} * ( 1 + {t}_{v} ) .$$

wherein tᵥ is a scaling factor, which can be experimentally altered to determine the best scaling values for C_{ISO1} and C_{ISO2}, for a given system. Alternatively, tᵥ may be mathematically derived, based on desired electrical conditions for the system. In some examples (which may be derived from experimental results), tᵥ may be in a range of about 3 to about 10.

FIG. 11A further illustrates an example for the receiver tuning system 34, which may be configured for utilization in conjunction with the voltage isolation circuit 70. The receiver tuning system 34 of FIG. 11A includes a controller capacitor C_{CONT}, which is connected in series with the data input of the receiver controller 38. The controller capacitor is configured for further scaling of V_{AC} at the controller, as altered by the voltage isolation circuit 70. To that end, the first and second isolation capacitors, as shown, may be connected in electrical parallel, with respect to the controller capacitor.

Additionally, in some examples, the receiver tuning system 34 includes a receiver shunt capacitor C_{RxSHUNT}, which is connected in electrical parallel with the receiver antenna 31. C_{RxSHUNT} is utilized for initial tuning of the impedance of the wireless receiver system 30 and/or the broader system 30 for proper impedance matching and/or C_{RxSHUNT} is included to increase the voltage gain of a signal received by the receiver antenna 31.

The wireless receiver system 30, utilizing the voltage isolation circuit 70, may have the capability to achieve proper data communications fidelity at greater receipt power levels at the load 16, when compared to other high frequency wireless power transmission systems. To that end, the wireless receiver system 30, with the voltage isolation circuit 70, is capable of receiving power from the wireless transmission system that has an output power at levels over 1 W of power, whereas legacy high frequency systems may be limited to receipt from output levels of only less than 1 W of power. For example, in legacy NFC-DC systems, the poller (receiver system) often utilizes a microprocessor from the NTAG family of microprocessors, which was initially designed for very low power data communications. NTAG microprocessors, without protection or isolation, may not adequately and/or efficiently receive wireless power signals at output levels over 1 W. However, inventors of the present application have found, in experimental results, that when utilizing voltage isolation circuits as disclosed herein, the NTAG chip may be utilized and/or retrofitted for wireless power transfer and wireless communications, either independently or simultaneously.

To that end, the voltage isolation circuits disclosed herein may utilize inexpensive components (e.g., isolation capacitors) to modify functionality of legacy, inexpensive microprocessors (e.g., an NTAG family microprocessor), for new uses and/or improved functionality. Further, while alternative controllers may be used as the receiver controller 38 that may be more capable of receipt at higher voltage levels and/or voltage swings, such controllers may be cost prohibitive, in comparison to legacy controllers. Accordingly, the systems and methods herein allow for use of less costly components, for high power high frequency wireless power transfer.

Returning to FIG. 9, in some example embodiments of the wireless receiver system 30, the wireless receiver system 30 may include functionality as an NFMI polling system, as discussed in more detail above. In such examples and as illustrated in FIG. 9, the receiver controller 38 of the wireless receiver system 30 may further include a driver 75, a communications demodulator 71, and a communications modulator 73. While each depicted as part of or integrated with the receiver controller 38, it is certainly possible that one or more components and/or functions of the communications demodulator 71, the communications modulator 73, and/or the driver 75 may be embodied by or functionally executed by other devices, hardware, or software, such as, but not limited to additional controllers or processors associated with the receiver controller 38, additional discrete components in electrical connection with the receiver controller 38, instructions stored on machine-readable media associated with the receiver controller 38, among other components external to the receiver controller 38.

As illustrated, the communications demodulator 71 may be electrically connected, via a data receipt signal path 171, to one or more of the receiver tuning system 34, the receiver antenna 31, or combinations thereof, such that the communications demodulator 71 can detect variances in a carrier signal (e.g., a wireless power signal, a polling signal, etc.) and subsequently determine or demodulate said variances to decode signals in-band of the aforementioned carrier signal. The communications modulator 73 may be electrically connected, via a data transmit signal path 173, to one or more of the receiver tuning system 34, the receiver antenna 31, or combinations thereof, such that the communications modulator can selectively alter a carrier signal (e.g., a wireless power signal, a polling signal, etc.) and subsequently insert said variances to encode signals in-band of the aforementioned carrier signal. Further, the driver 75 may be electrically connected, via a driving signal path 175, to one or more of the receiver tuning system 34, the receiver antenna 31, or combinations thereof, such that the driver 75 and/or any discrete or IC components connected thereto may provide signals and/or instructions for driving the receiver antenna 31, to generate a polling signal when the wireless receiver system 30 is operating in a polling operating mode.

To that end, while the drawing and description of FIGS. 10A and 11A, above, generally refers to functions of the wireless receiver system 30 and components thereof in the wireless power receiver mode, FIG. 10B and FIG. 11B are exemplary of a polling operating mode for the wireless receiver system 30.

Turning to FIG. 11A, an electrical schematic diagram 130A of a first operating state for the wireless receiver system 30A is illustrated, with lines indicating signal paths for one or more input and/or output signals to a controller 138, which may be utilized by the wireless receiver system 30, 30A as the receiver controller 38. As illustrated, the controller 138 includes a plurality of points or pins for electrical contact with one or more other components of the wireless receiver system 30. To that end, each of the illustrated points or pins of the controller may be an input to the controller 138, an output of the controller 138, an input/output pin of the controller 138, a general purpose input/output (GPIO) pin of the controller 138, a programmable GPIO pin of the controller 138, a dedicated input to a component, in silicon, of the controller 138, among other contemplated inputs or outputs to the controller, each of which may have either programmable functionality or fixed/dedicated functionality.

To that end, the illustrated example of the controller 138 includes, at least, output pins for the driver 75 (TX (POLL)+, TX (POLL)−), signal receipt or input pins for the communications demodulator 71 (COMMS (DEMOD)+, COMMS (DEMOD)−), and signal output or modulating input pins for the communications modulator 73 (COMMS (MOD)+, COMMS (MOD)−).

The aforementioned description of the wireless receiver system 30, generally, discussed the wireless receiver system 30, when it is operating in a first of two or more operating modes for wireless activity. For example, the aforementioned first operating mode of the wireless receiver system 30, as more specifically illustrated in FIGS. 10A and 11A, is a wireless power receiver mode. While referenced as a “wireless power receiver mode,” as will be clear in view of the discussion below, the wireless power receiver mode may include transmission and/or receipt of wireless data signals, in-band of a carrier signal.

As illustrated in FIG. 11A via solid, heavily bolded lines in an electrical schematic diagram 130A of the first operating state of the wireless receiver system 30A, the wireless receiver system 30A receives wireless power signals, via, for example, a first receiver antenna 131A, which may be implemented as the receiver antenna 31. The wireless power signals received, as shown, follow a signal path to the rectifier 33 (see, e.g. “TO 33”), when, for example, a switch is on for providing power signals to the rectifier 33.

In some such examples, a switch 150 is utilized to switch between first and second operating modes. In the example of the first operating mode for the wireless receiver system 30A, the switch 150 is in a first position 151, wherein signals are blocked or shorted between the receiver antenna 131A and pin inputs for the driver 75 (“TX(POLL)”). Rather, with the antenna 131A not connected to the driver 75, when in the first operating mode for the wireless receiver system 30A, the signal path for wireless power receipt and harvesting, at the rectifier 33, is maintained for wireless power receipt. The switch 150 may switch to and/or from the first operating mode based on instructions provided to the switch 150 from a controller, such as the controller 38, 138 and/or any other controller associated with the wireless receiver system 30 and/or a host device thereof. For example, a power management integrated circuit (PMIC) associated with the host device of the wireless receiver system 30 may provide instructions to set the wireless receiver system 30 in the first operating mode; said instructions may be provided to the switch 150 directly by the PMIC and/or may be provided to the controller 38, 138, which subsequently utilizes the switch 150 to set the wireless receiver system 30 in the first operating mode.

As illustrated in FIGS. 11, the communications demodulator 71 is connected to one or more of the receiver antenna 131A, the receiver tuning system 34, or combinations thereof via the data receipt signal path 171, which, as illustrated, may flow through, at least in part, the voltage isolation circuit 70. In such examples, the controller 38, 138 and/or the communications demodulator 71 determines communications signals encoded in band of the wireless power signals at, for example, demodulation pins (e.g., COMMS (DEMOD)+, COMMS (DEMOD)−). Further, as illustrated, the communications modulator is connected to one or more of the receiver antenna 131, the receiver tuning system 34, or combinations thereof via the data transmit signal path 173, which, as illustrated, may flow through other components (e.g., resistors, capacitors, etc.) that may assist in modulating the wireless power signal for encoding communications. In such examples, the controller 38, 138 and/or the communications modulator 73 encodeds the communications signals in band of the wireless power signals via, for example, modulation pins (e.g., COMMS (MOD)+, COMMS (MOD)−

Turning back to FIG. 10B, a block diagram illustrates components of the wireless receiver system 30, when utilized in a second operating mode for the wireless receiver system 30B. The second operating mode for the wireless receiver system 30B may be a polling mode for the wireless receiver system 30. As illustrated, when utilized in the polling mode, one or more components of the wireless receiver 30 may be either inactive or bypassed, such as, but not limited to, the rectifier 33, the voltage regulator 35, the voltage isolation circuit 70, etc. To that end, the receiver controller 38 may receive electrical energy or power from the load 16 and utilize said power in driving the receiver antenna 31, via the driver 75, for generating polling signals for wireless data communications.

To further illustrate functionality in the second operating mode for the wireless receiver system 30B, a second electrical schematic diagram 130B for the second operating mode for the wireless receiver system 30B is illustrated in FIG. 11B. As illustrated via solid, bolded arrowed lines, when the second operating mode for the wireless receiver system 30B is selected or functional, then polling signals, for driving the receiver antenna 131A, 31, are communicated from the receiver controller 38, 138 to the receiver antenna 131A, 31. Thus, the driver 75 of the receiver controller 38, 138 is utilized to generate NFMI signals that have enough power to provide at least some power to a passive device and, ultimately, act as a carrier signal for in-bound and out-bound data communications.

As illustrated in FIG. 11B, when operating in the second operating mode for the wireless receiver system 30B, the switch 150 may be switched to a second position 152, wherein components and/or wires connecting the controller 38, 138 to one or more of the receiver antenna 131A, 31, the receiver tuning system 34, or combinations thereof. Thus, when in the second operating mode, the receiver controller 38, 138 is configured to drive the antenna 131A, 31, to provide a carrier signal for data communications. In some examples, the switch 150 may switch to the second operating mode based on instructions, provided either by the controller 38, 138 or another host controller associated with a host device of the wireless receiver system 30. In some such examples, the wireless receiver system 30 may be utilized as a data pass-through device for wireless data transmission and/or receipt, for a host device of the wireless receiver system 30.

As illustrated, the communications demodulator 71 is connected to one or more of the receiver antenna 131A, the receiver tuning system 34, or combinations thereof via the data receipt signal path 171, which, as illustrated, may flow through, at least in part, the voltage isolation circuit 70. In such examples, the controller 38, 138 and/or the communications demodulator 71 determines communications signals encoded in band of carrier polling signals at, for example, demodulation pins (e.g., COMMS (DEMOD)+, COMMS (DEMOD)−). Further, as illustrated, the communications modulator is connected to one or more of the receiver antenna 131, the receiver tuning system 34, or combinations thereof via the data transmit signal path 173, which, as illustrated, may flow through other components (e.g., resistors, capacitors, etc.) that may assist in modulating the polling signals for encoding communications. In such examples, the controller 38, 138 and/or the communications modulator 73 encodeds the communications signals in band of the wireless power signals via, for example, modulation pins (e.g., COMMS (MOD)+, COMMS (MOD)−

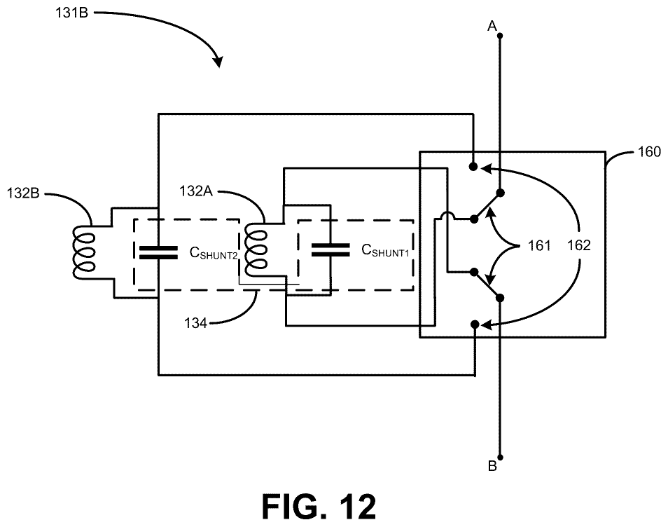

While illustrated as a single antenna 131A for implementing the receiver antenna 31 of the wireless receiver system 30, it is certainly contemplated that the receiver antenna 31 may be implemented by a plurality of antennas and/or coils thereof. For example, FIG. 12 illustrates an example embodiment of an antenna 131B, which may be utilized with any of the systems or operating states thereof of the wireless receiver system(s) 30, 30A, 30B that includes two antenna coils 132A, 132B. In such examples, the two antenna coils 132A, 132B may be connected to an antenna switch 160, which switches based on the operating mode for the wireless receiver system 30. For example, if the wireless receiver system 30 is operating in the first operating mode for the wireless receiver system 30A, then the antenna switch 160 may be in a first antenna switch position 161, which connects the first antenna coil 132A, ultimately, to the rectifier 33. In such examples, the first antenna coil 132A is configured for receipt of wireless power signals and, optionally, can be utilized in a signal path for modulating or demodulating communications in-band of the wireless power signals. Alternatively, if the wireless receiver system 30 is operating in the second operating mode for the wireless receiver system 30B, then the antenna switch 160 may be in a second antenna switch position 162, which connects the second antenna coil 132B, ultimately, to the driver 75. In such examples, the second antenna coil 132B is configured for transmitting a polling signal and can be utilized in a for modulating or demodulating communications in-band of the polling signals.

Example switches that may be utilized as one of the switch 150 and/or the antenna switch 160 may include, but are not limited to including, a digital switch receiving instructions from the controller 38, a manual switch responsive to input from a user, a single pole double throw (SPDT) switch, a double pole single throw switch, a solid state relay switch, a metal-oxide-semiconductor (MOSFET) switch, among other known electrical switches.

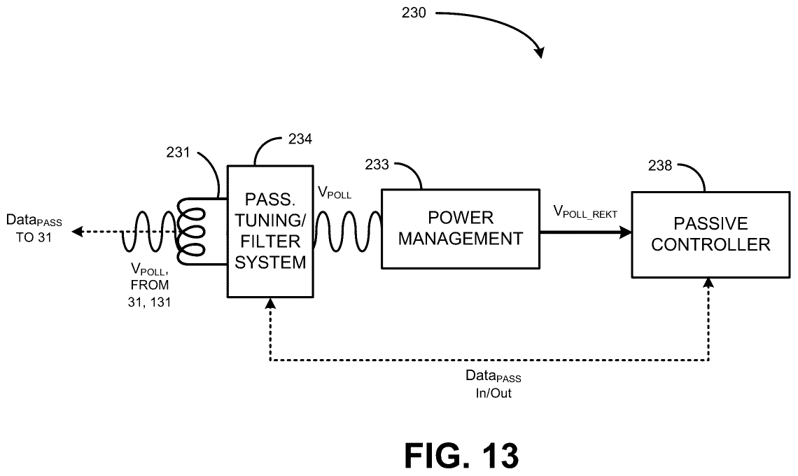

Referring now to FIG. 13 and with continued reference to FIGS. 9-12, an example passive NFMI device 230 is illustrated. As discussed above, the passive NFMI device 230 may not be consistently or permanently electrically connected to a direct electrical power source, such as a battery or a wired electrical power input.

As illustrated, the passive NFMI device may include common and/or similar components to those of the wireless receiver system(s) 30, discussed above with respect to FIGS. 9-12. Common elements are labelled having the same reference numbers to those of FIGS. 9-12, although the data, input, and/or output associated with the common elements may be of a more specific and/or different form. Similar elements may be labelled having a common two least significant digits as its similar element of the system(s) 30 of FIGS. 9-12 (e.g., the passive tuning system 234 is similar to the receiver tuning system 34). Accordingly, the descriptions, above, of the similar or common components are applicable to the corresponding components of the passive NFMI device 230.

The passive NFMI device 230 may receive electrical energy, for its operations, via NFMI power receipt at a passive antenna 231 of the passive NFMI device 230. The electrical signals, such as polling signals, are received via the passive antenna 231 and its associated tuning system 234, and converted into usable electrical energy at, for example, a power management system 233. The power management system 233 may include any components, discussed above with respect to one or more of the power conditioning system 40, rectifier 33, the voltage regulator 35, components thereof, or combinations thereof. Output of the power management system 233 may be utilized to energize, at least, the passive controller 238, which may be utilized for communications with, for example, a wireless receiver system 30. In some examples, the power management system 233 may be part of and/or integrated with the passive controller 238.

As discussed, the passive controller 238 may include like or similar elements to the discussed receiver controller(s) 38, 138, and accordingly, the passive controller may include or otherwise be associated with one or more modulation and/or demodulation systems or apparatus. Accordingly, the passive controller 238 may include at least one non-transitory machine-readable medium that includes instructions, that are executable by the passive controller 238, such that the controller is configured to perform any of the functions or actions discussed herein. To that end, the passive controller 238 may be configured to modulate the received polling signals to encode data signals in-band of the polling signals, which may then be decoded by the transmitter of the polling signals, which may be a wireless receiver system 30. Further, in some examples, the passive controller 238 is configured to demodulate the polling signals to decode data signals that are in-band of the polling signals, which may have been encoded into the polling signals by the wireless receiver system 30.

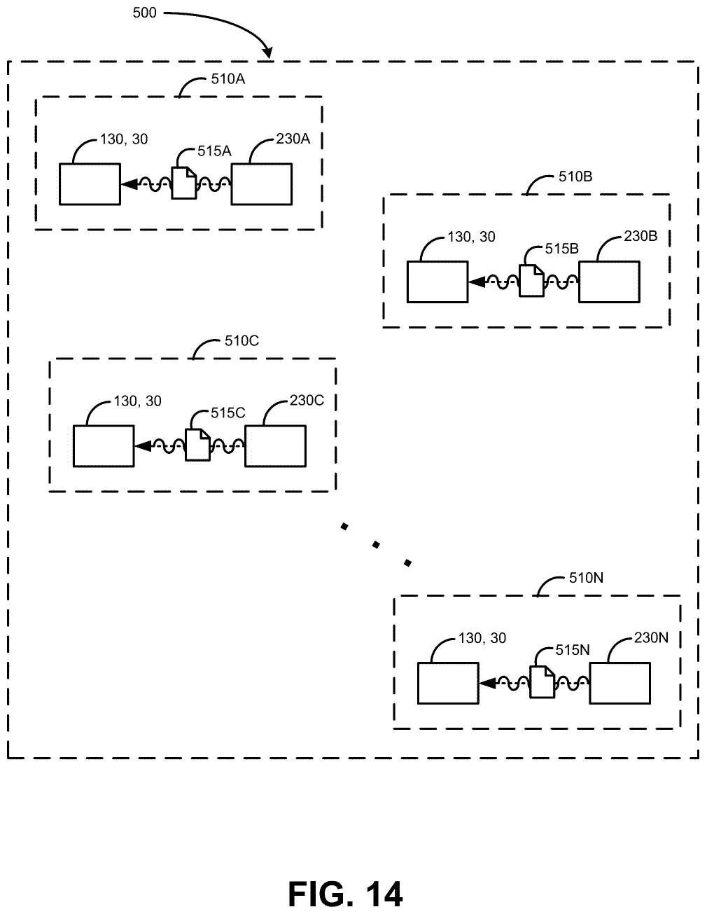

Accordingly, by utilizing the dual-functionality of the wireless receiver system 30 to enable the transceiver capabilities, for communications with passive NFMI device(s) 230, additional functionality may be included in a product associated with the wireless receiver system 30, with minimal component addition and/or changes in BOM. Further, as will be discussed with respect to FIG. 14, use of the wireless receiver system 130 for data transceiver capabilities, may be useful for detecting and/or differentiating between locations within an environment.

To that end, FIG. 14 is a two-dimensional map indicative of a plurality of locations 510A-N within an environment 500. As illustrated, one or more of the plurality of locations 510A-N may have a respective passive NFMI device 230A-N associated with the respective locations 510-A-N. The association of a passive NFMI device 230A-N with a location 510A-N may be permanent, semi-permanent, or temporary; in other words, the passive NFMI device 230A-N may be permanently affixed to or positioned within a respective location 510A-N, the passive NFMI device 230A-N may be affixable and/or removable with respect to the respective location 510A-N, or the passive NFMI device 230A-N may be temporarily placed within a respective location 510A-N.

Accordingly, the wireless receiver system 30 may be utilized to determine a location 510 within the environment 500 by activating, detecting, and/or communicating with a respective passive NFMI device 230 that is associated with a given location 510. For example, if polling and subsequent communications between the wireless receiver system 130 and a passive NFMI device 230A indicates, specifically, that the passive NFMI device 230A is associated with the location 510A, then the wireless receiver system 30 and/or a host device thereof can determine that the wireless receiver system 30 is now located proximate to the location 510A. For example, the passive NFMI device 230A may be activated, via NFMI, by the wireless receiver system 130 and the NFMI device 230A may then transfer location data 515A associated with the location 510A to the wireless receiver system 130, in-band of the polling signals. To that end, each of the passive NFMI devices 230A-N may store and transmit respective location data 515A-N, associated with the respective locations 510A-N.

Then, consider the wireless receiver system 130 is moved from the location 510A and positioned proximate to another location 510C; accordingly, polling and subsequent communications of the location data 515C to the wireless receiver system 130 by the passive NFMI device 230C indicates, specifically, that the wireless receiver system 30 and/or a host device thereof is now located proximate to the location 510C.

Example environments 500, within which more specific locations 510 reside, include, but are not limited to including, a business facility, a recreational facility, a home or residence, a human body, an animal body, a vehicle interior or exterior, an entertainment center, a municipality, a state, among other known locations. Accordingly, example respective locations 510, which may be existing within a larger or broader environment 500 include, but are not limited to including, a desk or workspace of a business facility, a station or piece of equipment within a recreational facility, a room or specific location within a home, a location proximate to one or more of a limb, tissue, organ, and/or other subdivision or body part of a human body, a location proximate to one or more of a limb, tissue, organ, and/or other subdivision or body part of an animal body, a specific vehicle part within or external to a vehicle, one or more specific pieces of entertainment equipment (e.g., a game console, a controller, a remote control, a speaker, a display, etc.), an indicator of a specific street and/or area within a municipality, among other known locations or positions within a broader environment 500.

While the example wireless transmission system(s) 20, wireless receiver system(s) 130, and/or passive NFMI devices 230 may be utilized for communications using a plurality of systems and methods for encoding, decoding, transmitting, receiving, and/or otherwise communicating via in-band communications, these systems 20, 30, and/or the passive NFMI device 230 may be utilized in for NFMI wireless power and wireless communications systems that are optimized for power transfer and data speeds that exceed traditional NFMI systems, such as NFC and/or NFC-WLC systems. To that end, the systems and methods, discussed below, may be utilized by the aforementioned system(s) 20, 30, and/or the passive NFMI device 230 for wireless power and data transfer.

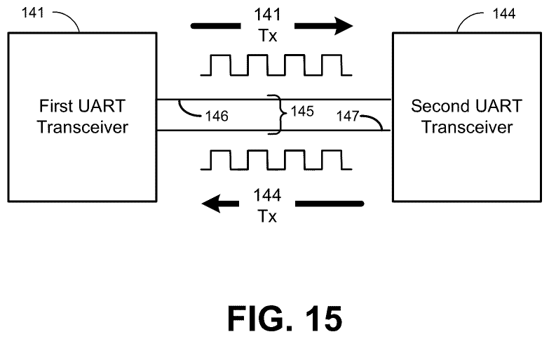

Turning to FIG. 15, this figure is a schematic functional plot of physically, electrically connected (e.g., wire connected) two-way data communications components, otherwise known as transceivers, which are overlaid with example communications. The communications between such two-way wired data communication components may include, but are not limited to including, data communications and/or connections compliant with a serial and/or universal asynchronous receiver-transmitter (UART) based protocol; however, such two-way wired data communications, and/or any simulations thereof, are certainly not limited to UART based protocol data communications and/or connections.

UART provides a wired serial connection that utilizes serial data communications over a wired (human-tangible, physical electrical) connection between UART transceivers, which may take the form of a two-wire connection. UART transceivers transmit data over the wired connection asynchronously, i.e., with no synchronizing clock. A transmitting UART transceiver (e.g., a first UART transceiver 141, as illustrated) packetizes the data to be sent and adds start and stop bits to the data packet, defining, respectively, the beginning and end of the data packet for the receiving UART transceiver (e.g., a second UART transceiver 144). In turn, upon detecting a start bit, the receiving UART transceiver 144 reads the incoming bits at a common frequency, such as an agreed baud rate. This agreed baud rate is what allows UART communications to succeed in the absence of a synchronizing clock signal.

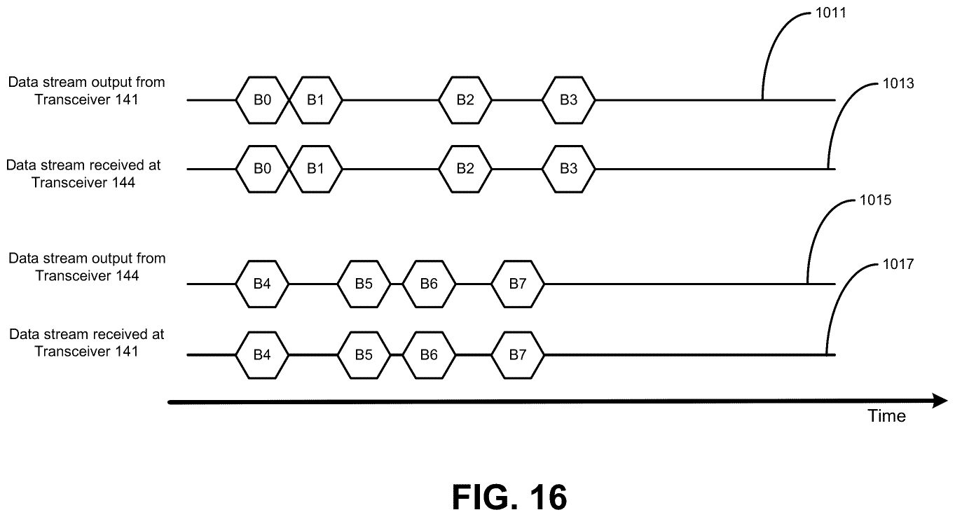

In the illustrated example, the first UART transceiver 141 may transmit a multi-bit data sequence (such as is shown in the data diagrams of FIG. 16) to the second UART transceiver 144, via UART communication, and likewise, the second UART transceiver 144 may transmit a multi-bit data element to the first UART transceiver 141. For instance, a UART-encoded signal representing a multi-bit data element may be transmitted over a two-wire connection 145 between the first UART transceiver 141 and the second UART transceiver 144. As shown in the illustrated example, a first wire 146 of the two-wire connection 145 may be used for communication in one direction while a second wire 147 of the two-wire connection 145 may be used for communication in the other direction.

FIG. 16 is a timing diagram showing packetized communications of a multi-bit data element over a standard wired UART connection, such as that shown in FIG. 15. In the illustrated example, the first multi-bit data element, for transmission from the first UART transceiver 141 to the second UART transceiver 144, is a first 4-bit number B₀B₁B₂B₃. As can be seen, this number is serialized as a single bit stream for transmission and subsequent receipt over the UART connection. The top data stream 1011 shows an example of the serial data stream as output from the first UART transceiver 41, while the second data stream 1013 shows the data stream 1011 as it is then received over the UART connection at transceiver 144. Similarly, the data streams 1015 and 1017 represent the transmission by the second UART transceiver 144 of a second 4-bit number B₄B₅B₆B₇ and receipt by the first UART transceiver 141 of that data.

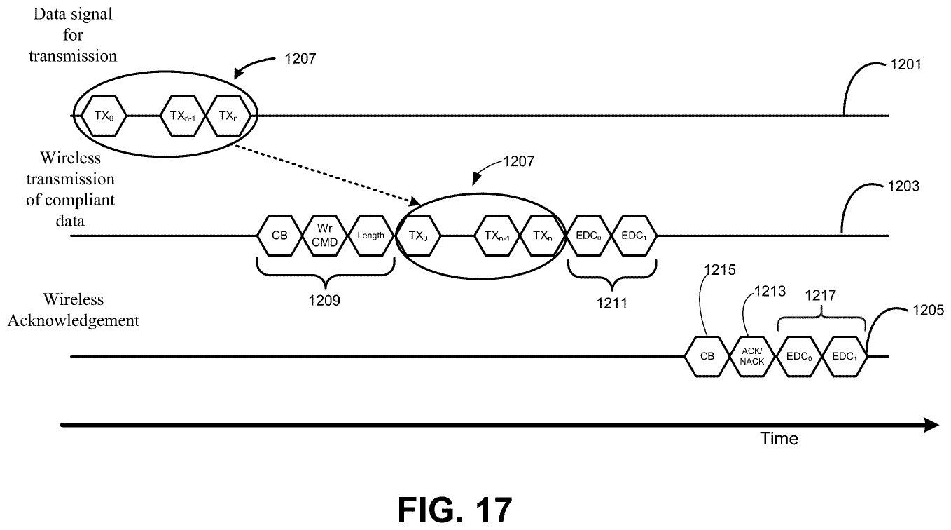

While wired, two-wire, simultaneous two-way communications are a regular means of communication between two devices, it is desired to eliminate the need for such wired connections, while simulating and/or substantially replicating the data transmissions that are achieved today via wired two-way communications, such as, but not limited to serial wired communications that are compliant with UART and/or other data transmission protocols. To that end, FIGS. 17-20 illustrate systems, methods, and/or protocol components utilized to to carry out such serial two-way communications wirelessly via the wireless power transfer system 10.

Turning to FIG. 17, this figure shows a set of a vertically-registered signal timing diagrams associated with a wireless exchange of data and associated communications over a wireless connection, as a function of time, in accordance with the present disclosure. For example, the wireless connection herein may be the magnetic coupling of the transmission antenna 21 and the receiver antenna 31 of, respectively, the wireless transmission system 20 and the wireless receiver system 30, discussed above. In this situation, the wireless exchange of data occurs between the wireless transmission system 20 and the wireless receiver system 30. It should be noted that data transferred over the wireless connection may be generated, encoded, and/or otherwise provided by one or both of the transmission controller 28 and the receiver controller 38. Such data may be any data, such as, but not limited to, data associated with the wireless transmission of electrical energy, data associated with a host device associated with one of the wireless transmission system 20 or the wireless receiver system 30, or combinations thereof. While illustrated in FIG. 17, along with the proceeding drawings, as a transfer of data from the wireless transmission system 20 to the wireless receiver system 30, as mentioned, the simulated serial communications between the systems 20, 30 may be bidirectional (i.e., two-way), such that both systems 20, 30 are capable of transmission, receipt, encoding, decoding, other bi-directional communications functions, or combinations thereof.

The originating data signal 1201 is an example UART input to the wireless transmission system 20, e.g., as a UART data input to the wireless transmission system 20 and/or the transmission controller 28 and/or as a UART data input to the wireless receiver system 30 and/or the receiver controller 38. While the figure shows the data originating at and transmitted by the wireless transmission system 20/transmission controller 28, the transmission controller 28 and/or the receiver controller 38 may communicate data within the power signal by modulating the inductive field between the antennas 21, 31 to communicate in the frequency band of the wireless power transfer operating frequency.

The wireless serial data signal 1203 in FIG. 17 shows a resultant data stream conveying the data of the originating data signal 1201 as an encapsulated transmission. The acknowledgment signal 1205, shown in FIG. 17, represents a transmission-encapsulated acknowledgment (ACK) or non-acknowledgement (NACK) signal, communicated over the near field magnetic connection, by the receiver controller 38, upon acknowledgment or non-acknowledgement of receipt of the wireless serial data signal 1203, by the receiver controller 38.

Turning to the specific contents of each signal in FIG. 17, the originating data signal 1201 includes an n-byte data element 1207 comprised of bytes Tₓ₀ . . . Tₓₙ₋₁, Tₓₙ. In the wireless serial data signal 1203, the data stream may include a command header 1209 and a checksum 1211, in accordance with the particular transmission protocol in use in the example. “n” indicates any number of bytes for data elements, defined herein. For example, the command header 1209 may include a Control Byte (“CB”), Write command (“Wr CMD”) and Length code (“Length”). The Control Byte contains, for example, information required to control data transmission of blocks. The Write command may include information specifying that encapsulated data is to be written at the receiving end. The Length code may include information indicating the length of the n-byte data element 1207. The checksum 1211 may be a datum used for the purpose of detecting errors and may be determined by or generated from a checksum algorithm. The ACK signal 1213 from the receiver is similarly encapsulated between a CB 1215 and a checksum 1217.

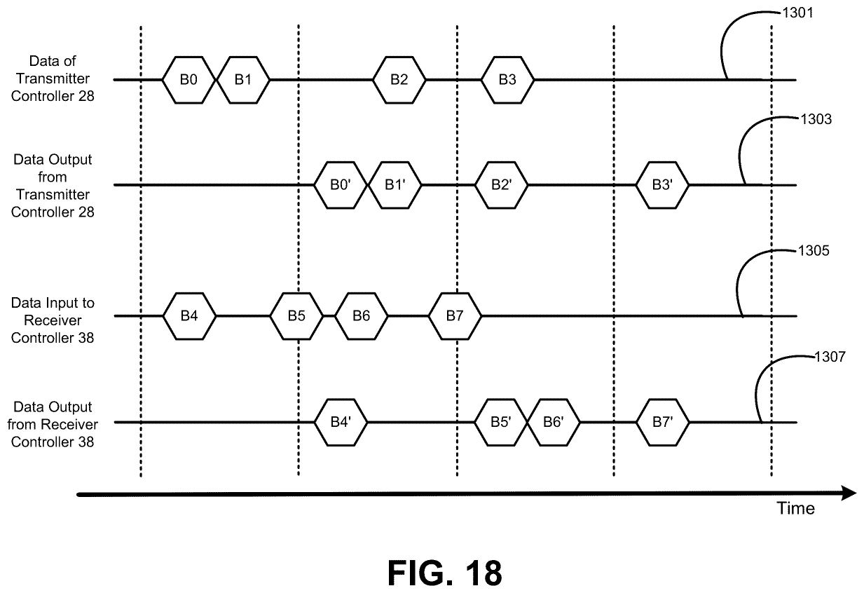

FIG. 18 is a timing diagram showing receiver and transmitter timing functions in accordance with the present disclosure. For example, the receiver timing functions may be the timing of data transmission/receipt at the receiver controller 38 and the transmitter timing functions may be the timing of data transmission/receipt at the transmission controller 28. In this example, the receiver and transmitter timing utilizes a slotted protocol, wherein certain slots of time are available for data transmission, as in-band data communications of the wireless power signal between the transmission antenna 21 and the receiver antenna 31. Utilizing such timing and/or protocol may provide for virtually simultaneous data transfer between the transmission controller 28 and the receiver controller 38, as both the transmission controller 28 and the receiver controller 38 may be capable of altering an amplitude (voltage/current) of the magnetic field between the antennas 21, 31. “Virtually simultaneous data transfer” refers to data transfer which may not be actually simultaneous, but performed at a speed and with such regular switching of active transmitter of data (e.g., the wireless transmission system 20 or the wireless receiver system 30), such that the communications provide a user experience comparable to actual simultaneous data transfer.

In the illustrated embodiment, the first line 1301 shows an incoming stream of bytes B₀, B₁, B₂, B₃, to the transmission controller 28. If the transmission controller 28 is configured to transmit data in time slots, then the incoming bytes are slightly delayed and placed into sequential slots as they become available. In other words, data that arrives during a certain time slot (or has any portion arriving during that time slot) will be placed into a subsequent time slot for transmission. This is shown in the second line 1303, which shows data to be transmitted over the wireless link, e.g., a wireless power and data connection. As can be seen, each byte is sent in the subsequent slot after the data arrives at the transmission controller 28, from, for example, a data source associated with the wireless transmission system 20. Further, a third line 1305 shows an incoming stream of bytes B₅, B₆, B₇, B₈, to the receiver controller 38. If the receiver controller 38 is configured to transmit data in time slots, then the incoming bytes are slightly delayed and placed into sequential slots as they become available. In other words, data that arrives during a certain time slot (or has any portion arriving during that time slot) will be placed into a subsequent time slot for transmission. This is shown in the fourth line 1307, which shows data to be transmitted over the wireless link, e.g., a wireless power and data link. As can be seen, the analog of each byte is sent in the subsequent slot after the data arrives at the receiver controller 38 from, for example, a data source associated with the wireless receiver system 30.

In a buffered system, communications can be held in one or more buffers until the subsequent processing element is ready for communications. To that end, if one side is attempting to pass a large amount of data but the other side has no need to send data, communications can be accelerated since they can be sent “one way” over the virtual “wire” created by the inductive connection. Therefore, while such electromagnetic communications are not literally “two-way” communications utilizing two wires, virtual two-way UART communications are executable over the single inductive connection between the transmitter and receiver.

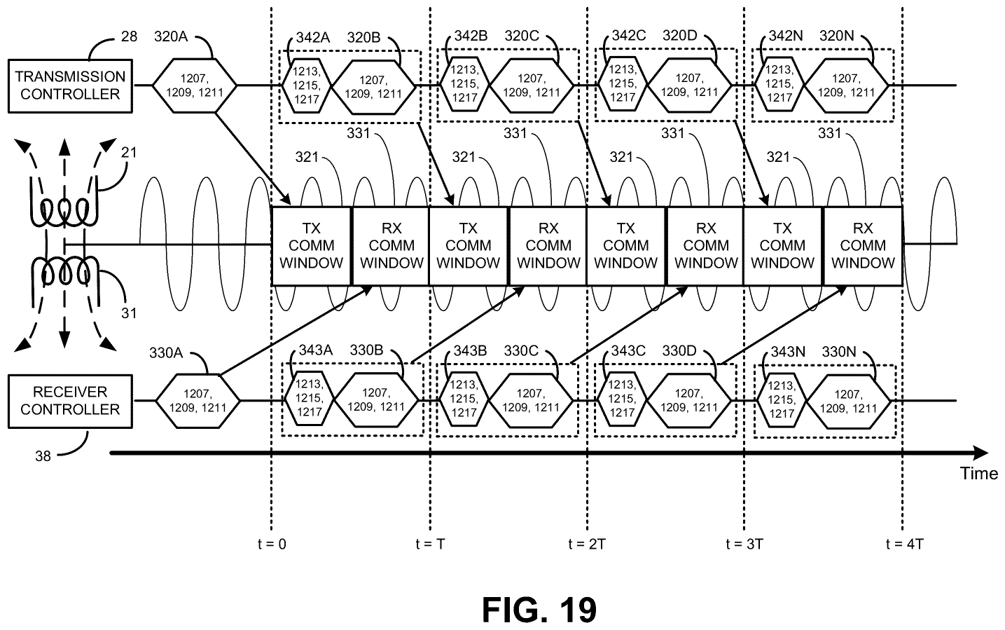

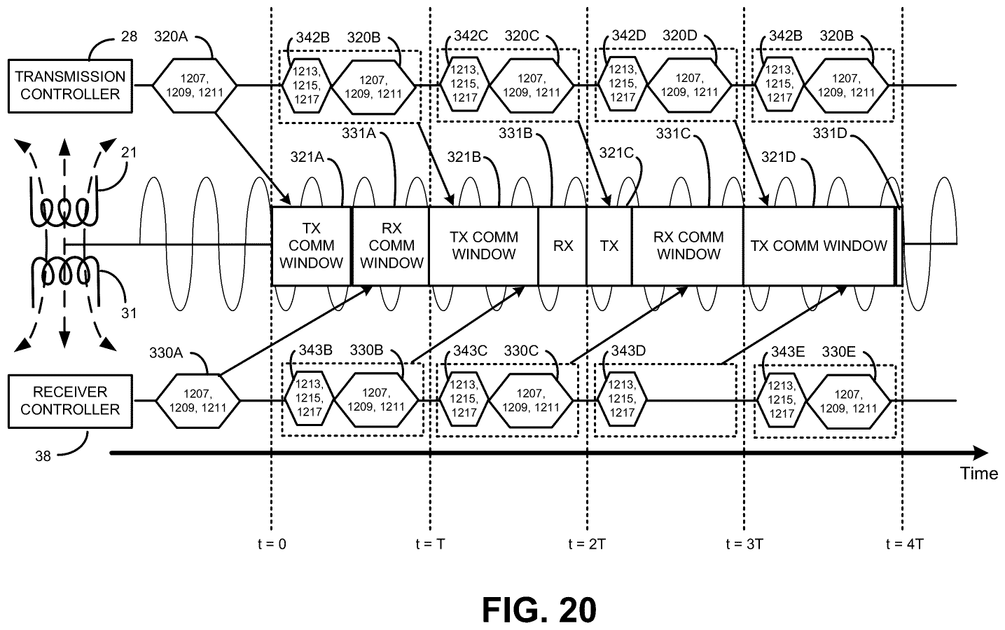

To that end, as illustrated in FIGS. 19 and 20, two-way communications may be achieved by windowing a period of time, within which each of the wireless transmission system 20 and the wireless receiver system 30 encode their data into the power signal/magnetic field emanating between the antennas 21, 31. FIG. 19 shows a timing diagram, wherein data 320, 330 at the systems 20, 30, respectively, are prepared for transmission and subsequently encoded into the signal during respective transmission communication windows 321 and receiver communication windows 331. As illustrated, the systems 20, 30 and/or controllers 28, 38 may be configured to store, transmit, and encode data 320, 330 into the resultant signal emanating between the antennas 21, 31. Such controllers 28, 38 may be configured to encode said data 320, 330 within the windows 321, 331, within a given and known (by both controllers 28, 38) period of time (T). As such, the time scale in FIGS. 19 and 20 is labelled with recurring periods for the time, as indicated by the vertical dotted lines. Further, while the windows 321, 331 are illustrated as consuming entire periods T of the signal, the windows 321, 331 do not necessarily consume an entire period T and may be configured as a fraction of the period T, but recurring and beginning at intervals of the period T.

Each of the transmission controller 28 and the receiver controller 38 may be configured to transmit a stream of the data 320A-N, 330A-N, respectively, to the other controller 28, 38, in a sequential manner and within the respective windows 321, 331. The period T and/or the windows 321, 331 may be of any time length suitable for the data communications operation used. However, it may be beneficial to have short periods and windows, such that the switching of senders (controllers 28, 38) is not perceptible by the user of the system. Thus, to achieve high data rates with short windows and periods, the power signal may be of a high operating frequency (e.g., in a range of about 1 MHz to about 20 MHz). To that end, the data rates utilized may be up to or exceeding about 1 megabit per second (Mbps) and, thus, small periods and windows therein are achievable.

Further, while the windows in FIG. 19 are illustrated as relatively equal, such window sizes may not be equal. For example, as illustrated in FIG. 20, the length of the windows 321, 331 may dynamically alter based on, for example, the desired data operations needed. Thus, the length of the windows 321, 331 within each slot may lengthen or shrink, with respect to one another, based on operating conditions. For example, as illustrated at windows 321B, 331B, the transmission communications window 321B may be significantly larger than the receiver communications window 331B. Such a configuration may be advantageous when the transmission system 20 desires to send a large amount of data (e.g., a firmware update, new software for the electronic device 14, among other software and/or firmware), while the receiver system 30 only needs to transmit regular wireless power related information.

Conversely, in some examples, such as those of illustrated by windows 321C, 331C, the receiver system 30 may need to send much more data than the transmission system 20 and, thus, the windows 321C, 331C are dynamically altered such that the receiver communications window 331C is larger, with respect to the transmission communications window. Such a configuration may be advantageous when the receiver system desires to send a large amount of data to the transmission system 20 and/or a device associated therewith. Example situations wherein this scenario may exist include, but are not limited to including, download of device data from the wireless receiver system 30 to a device associated with the wireless transmission system 20.

In an example exemplified by the windows 321D, 331D, the transmission communications window 321D may be so much larger than the receiver communications window 331D, such that the receiver communications window 331D, virtually, does not exist. Thus, this may put the transmissions system 20 in a virtual one-way data transfer, wherein the only data transmitted back to the transmission system 20 is a simple ACK signal 1213 and, in some examples, associated data such as the CB 1215 and/or checksum 1217. Such a configuration may be advantageous when the transmission system 20 is transmitting data and the receiver system 30 does not need to receive significant electrical power to charge the load 16 (e.g., when the load 16 is at a full load or fully charged state and, thus, the receiver system 30 may not need to send much power-related data).

In some examples, as illustrated, some data 320, 330 may be preceded by acknowledgment data 342, 343, which includes, but is not limited to including, at least the ACK signal 1213 and, in some examples, may further include a CB 1215 and/or a checksum 1217, each of which are discussed in more detail above. The acknowledgement data 342, 343 may be associated with an acknowledgement of receipt of a previously transmitted member of the stream of data 320A-N, 330A-N, within a subsequent window of the previously transmitted member of the stream of data 320A-N, 330A-N. For example, consider that in a first transmission communication window 321, a first data 320A is encoded and transmitted during the first period of time [t=0:T]. Then, a receiver acknowledgment data 343A will be encoded and transmitted, by the receiver controller 38, within a second receiver communications window 331, during a second period of time [t=T:2T].

Therefore, by encoding the data 320, 330, 342, 343 sequentially and within timed, alternating windows in the power signal of the antennas 21, 31, this may make the alternation of data passage nearly unnoticeable, and, thus, the communications are virtually simultaneously two-way, as the user experience does not register as alternating senders.

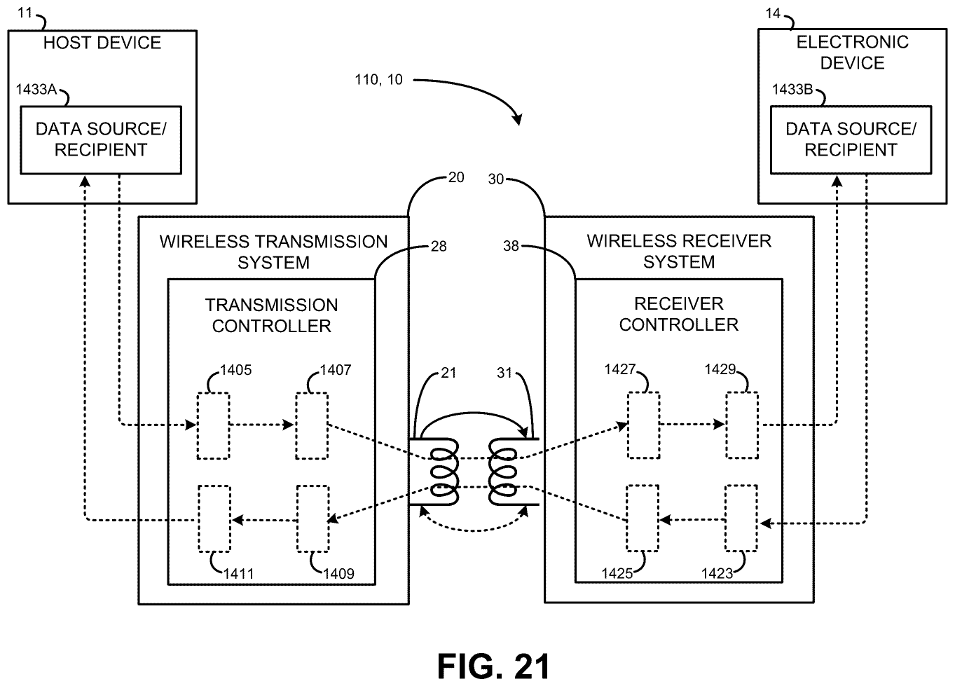

FIG. 21 is a block diagram 110 of a one or more components of the wireless power transfer system 10, including the transmission controller 28 and the receiver controller 38 of, respectively, the wireless transmission system 20 and the wireless receiver system 30. The block diagram 110 illustrates a configuration of the system 10 capable of buffering data in order to facilitate virtual two-way communications. The transmission controller 28 may receive data from a first data source/recipient 1433A associated with the wireless transmission system 20; however, it is certainly contemplated that the source of the data for the transmission controller 28 is the transmission controller 28 and/or any data collecting/providing elements of the wireless transmission system 20, itself. The data source/recipient 1433A may be operatively associated with a host device 11 that hosts or otherwise utilizes the wireless transmission system 20. Data provided by the data source/recipient 1433A may be processed by the transmission controller 28, transmitted from the transmission antenna 21 to the receiver antenna 31, processed by the receiver controller 38, and, ultimately, received by a second data source/recipient 1433B.

The second data source/recipient 1433B may be associated with the electronic device 14, which hosts or otherwise utilizes the wireless receiver system 30. The receiver controller 38 may receive data from a first data source/recipient 1433B associated with the wireless receiver system 30; however, it is certainly contemplated that the source of the data for the receiver controller 38 is the receiver controller 38 and/or any data collecting/providing elements of the wireless receiver system 30 itself. The data source/recipient 1433B may be operatively associated with an electronic device 14 that hosts or otherwise utilizes the wireless receiver system 30. Data provided by the data source/recipient 1433B may be processed by the receiver controller 38, transmitted over the field generated by the connection between the transmission antenna 21 and the receiver antenna 31, processed by the transmission controller 28, and, ultimately, received by a second data source/recipient 1433A. The second data source/recipient 1433A may be associated with the host device 11, which hosts or otherwise utilizes the wireless transmission system 20.

As shown, the illustrated example includes a series of buffers 1405, 1407, 1409, 1411, 1423, 1425, 1427, 1429, each associated with one of the transmission controller 28 or the receiver controller 38. The buffers 1405, 1407, 1409, 1411, 1423, 1425, 1427, 1429 may be used to properly order the data for transmission and receipt, especially when the communication between the wireless transmission system 20 and wireless receiver system 30 includes data of a type typically associated with a two-wire, physical, serialized data communications system, such as the UART transceivers of FIG. 10. In an embodiment, the output of the one or more buffers 1405, 1407, 1409, 1411, 1423, 1425, 1427, 1429 in the wireless power transmission system is clocked to trigger buffered data for transmission, meaning that the controller 28, 38 may be configured to output the buffered data at a regular, repeating, clocked timing

In the illustrated example, the transmission controller 28 includes two outgoing buffers 1405, 1407 to buffer outgoing communications, as well as two incoming buffers 1409, 1411 to buffer incoming communications. Similarly, the receiver controller 38 includes two incoming buffers 1429, 1427 to buffer incoming communications and two outgoing buffers 1423, 1425 to buffer outgoing communications.

The purpose of these two-buffer sets, in an embodiment, is to manage overflow by mirroring the first buffer in the chain to the second when full, allowing the accumulation of subsequent data in the now-cleared first buffer. Thus, for example, data entering buffer 1405 from data source 1433A is accumulated until buffer 1405 is full or reaches some predetermined level of capacity. At that point, the accumulated data is transferred into buffer 1407 so that buffer 1405 can again accumulate data coming from the data source 1433A. Similarly, for example, data entering buffer 1423 from data source 1433B is accumulated until buffer 1423 is full or reaches some predetermined level of capacity. At that point, the accumulated data is transferred into buffer 1425 so that buffer 1423 can again accumulate data coming from the data source 1433B. While the two-buffer sets are used in this illustration, by way of example, it will be appreciated that single buffers may be used or, alternatively, three-buffer or larger buffer sets may be used. Similarly, the manner of using the illustrated two-buffer sets is not necessary in every embodiment, and other accumulation schemes may be used instead.

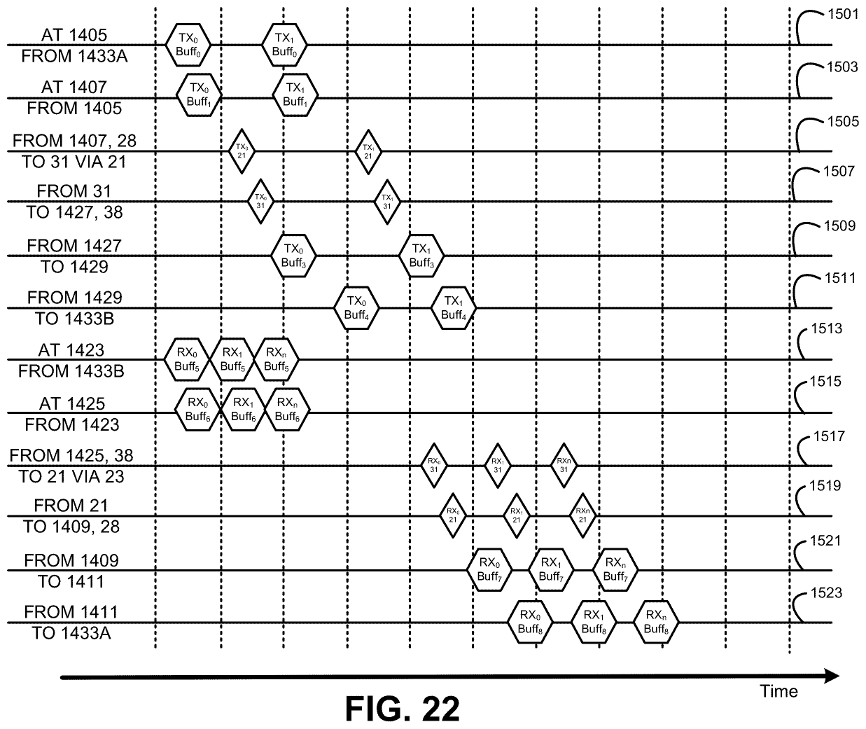

FIG. 22 is a timing diagram showing initial data input (lines 1501, 1513), buffering (lines 1501, 1503, 1513, 1515), and wireless transmission (lines 1505, 1507, 1517, 1519), as well as receipt (lines 1509, 1521), buffering (lines 1509, 1511, 1521, 1523), and data output (lines 1511, 1523) in the context of a configuration, such as that shown in FIG. 14. The first three lines of each data transfer (lines 1501, 1503, 1505, 1511, 1513, 1515) show a series of data transfers for sending asynchronous incoming data such as UART data across a wireless connection. The last three lines of each data transfer (lines 1507, 1509, 1511, 1519, 1521, 1523) show the receipt and processing of embedded data in a wireless transmission.

As can be seen, the data stream in the first two lines 1501, 1503, represent incoming data received and buffered at the transmission controller 28. The buffered data is then transmitted within the prescribed wireless data slots in line 1505, which may, for example, cover a very small portion of the transmission bandwidth. Note, that the wireless data slots have no bearing on the timing of data receipt/internal transfer within the controllers 28, 38, but may be utilized for timing the modulation of the induced field between the antennas 21, 31 that is utilized for transmission of data.

In the non-limiting example of FIG. 22, line 1501 shows a series of data packets from the transmission system 20 (TX₀ . . . TXₙ) sequentially input to a first outgoing buffer 1405 (Buff₀). Then, prior to transmission via the transmission antenna 21, the series of data packets (TX₀ . . . TXₙ) are input to the second outgoing buffer 1407 (Buff₁), as illustrated in line 1503. Then, the transmission controller 28 sequentially encodes the series of data packets (TX₀ . . . TX₁) into the driving signal for the transmission antenna 21 (line 1505) which is then received and/or detected in the magnetic field between the antennas 21, 31, at the wireless receiver system 30 (line 1507).

As noted above, the last three lines 1507, 1509, 1511 show the receipt and processing of embedded data in the wireless transmission, and in particular show wireless receipt of the data (line 1507), buffering of the received data (lines 1509, 1511) and outputting of the buffered data (line 1511). Again, the output of the one or more buffers in the wireless power transmission system may be clocked to trigger buffered data for transmission.

In the non-limiting example of FIG. 22 and with continued reference to FIG. 21, line 1507 shows a series of data packets originating from the transmission system 20 (TX₀ . . . TXₙ) and received at the receiver antenna 31 sequentially input to a first input buffer 1427 (Buff₃) of the receiver controller 38, upon sequential decoding of the series of data packets (TX₀ . . . TXₙ) by the receiver controller 38 detection of the magnetic field between antennas 21, 31. Then, prior to output of the data to the data recipient 1433B, the series of data packets (TX₀ . . . TXₙ) are input to a second input buffer 1429 (Buff₄) from the first input buffer (Buff₃), as illustrated in line 1511.

In the non-limiting example of FIG. 22, line 1501 shows a series of data packets (RX₀ . . . RXₙ) sequentially input to a third outgoing buffer 1423 (Buff₀). Then, prior to transmission via altering the field between the receiver antenna 31 and the transmission antenna 21, the series of data packets (RX₀ . . . RXₙ) are input to the fourth outgoing buffer 1425 (Buff₁), as illustrated in line 1503. Then, the receiver controller 38 sequentially encodes the series of data packets (RX₀ . . . RXₙ) into in band of the wireless power transfer between the antennas 21, 31 (line 1505), the signal is then received and/or detected in the magnetic field between the antennas 21, 31, at the wireless transmission system 20 (line 1507).

As noted above, the lines 1507, 1509, 1511 show the receipt and processing of embedded data in the wireless transmission, and in particular show wireless receipt of the data (line 1507), buffering of the received data (line 1509, 1511) and outputting of the buffered data (line 1511). Again, the output of the one or more buffers in the wireless power transmission system may be clocked to trigger buffered data for transmission.

As can be seen, the data stream in the lines 1513, 1515 represent incoming data received and buffered at the receiver controller 38. The buffered data is then transmitted within the prescribed wireless data slots in line 1517, which may, for example, cover a very small portion of the transmission bandwidth. Note, that the wireless data slots have no bearing on the timing of data receipt/internal transfer within the controllers 28, 38, but may be utilized for timing the modulation of the induced field between the antennas 21, 31 that is utilized for transmission of data.

In the non-limiting example of FIG. 22, line 1513 shows a series of data packets (RX₀ . . . RXₙ) originating at the receiver system 30 and sequentially input to a third outgoing buffer 1423 (Buff₅). Then, prior to transmission via altering the field between the receiver antenna 31 and the transmission antenna 21, the series of data packets (RX₀ . . . RXₙ) are input to the fourth outgoing buffer 1425 (Buff₆), as illustrated in line 1515. Then, the receiver controller 38 sequentially encodes the series of data packets (RX₀ . . . RXₙ) in band of the wireless power transfer between the antennas 21, 31 (line 1517), the signal is then received and/or detected in the magnetic field between the antennas 21, 31, at the wireless transmission system 20 (line 1519).

As noted above, the three lines 1519, 1521, 1523 show the receipt and processing of embedded data in the wireless transmission, and in particular show wireless receipt of the data (line 1519), buffering of the received data (lines 1521, 1523) and outputting of the buffered data (line 1523). Again, the output of the one or more buffers in the wireless power transmission system may be clocked to trigger buffered data for transmission.

In the non-limiting example of FIG. 22, line 1519 shows the series of data packets (RX₀ . . . RXₙ) sequentially input to a third input buffer 1409 (Buff₇) of the transmission controller 28, upon sequential decoding of the series of data packets (RX₀ . . . RXₙ) by the transmission controller 28 detection of the magnetic field between antennas 21, 31. Then, prior to output of the data to the data recipient 1433A, the series of data packets (RX₀ . . . RXₙ) are input to a fourth input buffer 1411 (Buff₅) from the third input buffer (Buff₇), as illustrated in line 1523.

As best illustrated in FIG. 21, by utilizing the buffers and the ability of both the transmission controller 28 and the receiver controller 38 to encode data into the wireless power signal transmitted over the connection between the antennas 21, 31, such combinations of hardware and software may simulate the two-wire connections (FIGS. 15, 16), depicted as dotted, arrowed lines in FIG. 21. Thus, the systems and methods disclosed herein may be implemented to provide a “virtual wired” serial and/or “virtual wired” UART data communications system, method, or protocol, for data transfer between the wireless transmission system 20 and the wireless receiver system 30 and/or between the host devices thereof. “Virtual wired,” as defined herein, refers to a wireless data connection, between two devices, that simulates the functions of a wired connection and may be utilized in lieu of said wired connection.

In contrast to the wired serial data transmission systems such as UART, as discussed in reference to FIGS. 15 and 16, the systems and methods disclosed herein eliminate the need for a wired connection between communicating devices, while enabling a data communication interpretable by legacy systems that utilize known data protocols, such as UART. Further, in some examples, such legacy-compatible systems may enable manufacturers to quickly introduce wireless data and/or power connections between devices, without needing to fully reprogram their data protocols and/or without having to hinder interoperability between devices.

Additionally or alternatively, such systems and methods for data communications, when utilized as part of a combined wireless power and wireless data system, may provide for much faster legacy data communications across an inductive wireless power connection, in comparison to legacy systems and methods for in-band communications.

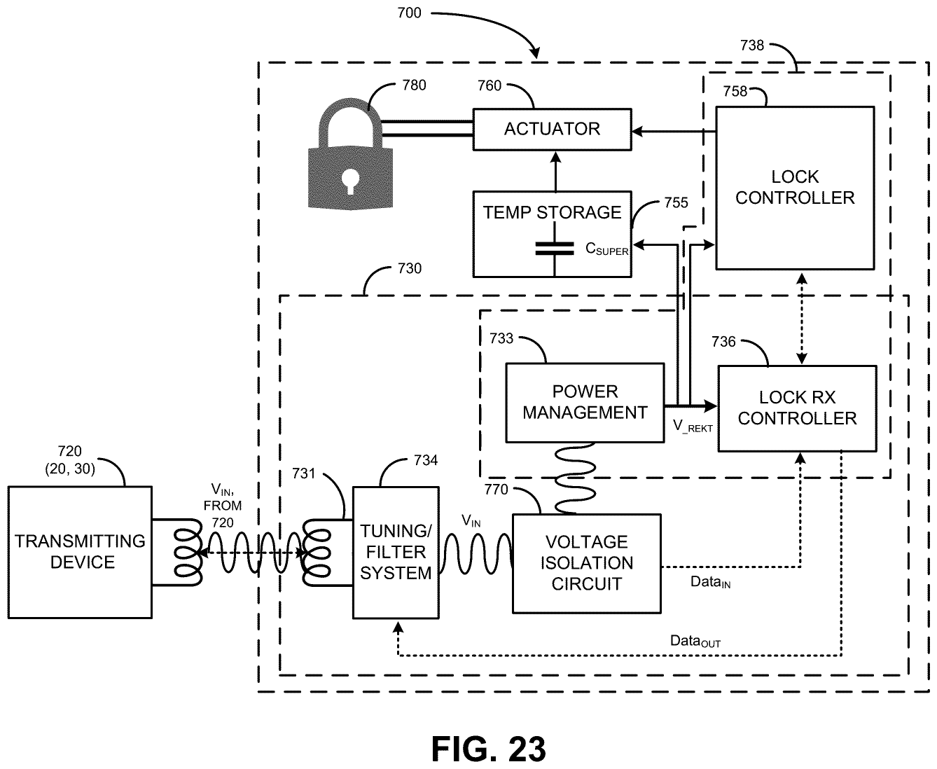

Turning now to FIG. 23, an example block diagram is illustrated which incorporates and/or utilizes one or more of the system(s) 20, 30, and/or the passive NFMI device 230, and/or components thereof, discussed above, for a lock system 700. The lock system 700 may include a wireless receiver system 730 that is configured to receive, at least, electrical energy and electrical data from one or more transmitting device 720. The transmitting device 720 may include one or more of the wireless transmission system 20, the wireless receiver system 30, or components thereof, such that the transmitting device 720 can transmit at least some electrical energy, for providing power to the lock system 700, and encode/decode communications signals in-band of the transmitted electrical energy. For example, the transmitting device 720 may be configured, similarly to the wireless receiver system 30, to transmit electrical energy via polling signals (e.g., at about 5 microWatts (μW) to about 300 mW).

As illustrated, the lock system 700 and/or the transmitting device 720 may include common and/or similar components to those of the wireless transmission system 20, the wireless receiver system(s) 30, and/or the passive NFMI device 230, discussed above with respect to FIGS. 1-14. Common elements are labelled having the same reference numbers to those of FIGS. 1-14, although the data, input, and/or output associated with the common elements may be of a more specific and/or different form. Similar elements may be labelled having a common two least significant digits as its similar element of the system(s) 20, 30, and/or the passive NFMI device 230 of FIGS. 1-14 (e.g., a tuning system 734 is similar to the receiver tuning system 34). Accordingly, the descriptions, above, of the similar or common components are applicable to the corresponding components of the transmitting device 720 and/or the lock system 700.

Upon receipt of the signals (V_{IN}) from the transmitting device 720 at an antenna 731 and/or the tuning system 734 of the wireless receiver system 730 of the lock system 700, wireless power and/or polling signals are received by a power management system 733. In some examples, a controller 738, which may include one or both of a lock receiver controller 736, a lock controller 758, or combinations thereof, may be isolated from voltage swings by a voltage isolation circuit 770, which is discussed in more detail above with respect to the voltage isolation circuit 70.

The power management system 733 converts received electrical signals into usable electrical energy. The power management system 733 may include any components, discussed above with respect to one or more of the power conditioning system 40, rectifier 33, the voltage regulator 35, the power management system 233, components thereof, or combinations thereof. Output of the power management system 733 may be utilized to energize, at least, the controller 738. In some examples, the power management system 733 may be part of and/or integrated with the controller 738.

The controller 738, including the lock receiver controller 736 and the lock controller 758, may include, but is not limited to including, one or more components for executing the functions disclosed herein, including at least one non-transitory machine-readable medium including program instructions for executing said functions. The controller 738 may be any electronic controller or computing system that includes, at least, a processor which performs operations, executes control algorithms, stores data, retrieves data, gathers data, controls and/or provides communication with other components and/or subsystems associated with the lock system 700. The controller 738 may be a single controller or may include more than one controller disposed to control various functions and/or features of the lock system 700. Functionality of the receiver controller 38 may be implemented in hardware and/or software and may rely on one or more data maps relating to the operation of the lock system 700.

As mentioned, the controller 738 may be operatively associated with memory. The memory may include one or both of internal memory, external memory, and/or remote memory. The internal memory and/or external memory may include, but are not limited to including, one or more of a read only memory (ROM), including programmable read-only memory (PROM), erasable programmable read-only memory (EPROM or sometimes but rarely labelled EROM), electrically erasable programmable read-only memory (EEPROM), random access memory (RAM), a flash memory, a portable memory, and the like. Such memory media are examples of non-transitory computer and/or machine readable memory media.

Further, while particular elements of the controller 738 are illustrated as subcomponents and/or circuits (e.g., the lock controller 758, the lock receiver controller 736, the power management system 733, among other contemplated elements), such components may be external of the controller 738. In some examples, the controller 738 may be and/or include one or more integrated circuits configured to include functional elements of one or both of the controller 738 and the lock system 700, generally.

The lock receiver controller 736 may be configured to communicate with the transmitting device 720 to, for example, verify that a user of the transmitting device 720 is authorized to lock and/or unlock a locking mechanism 780 of or associated with the lock system 700. For example, the transmitting device 720 may be configured to communicate a unique identifier, via NFMI, to the lock controller 758 via, for example, an intermediary communications means of the lock receiver controller 736; then, the lock controller 758 may verify if the unique identifier, transmitted via NFMI, and, if verified, allows the user to lock or unlock the locking mechanism 780. In some additional or alternative examples, the lock receiver controller and a controller of the transmitting device may perform bi-directional communications, via NFMI, to perform a verification or “handshake” step, in order to verify that the user of the transmitting device 720 should be allowed to lock or unlock the locking mechanism 780.

In some examples, the lock system 700 may be a passive lock system and, accordingly, utilizes power harvested by the wireless receiver system 730 to power one or more of an actuator 760 associated with the locking mechanism 780, the controller 738, a temporary energy storage device 755, or combinations thereof. To that end, for performing the aforementioned functions of the controller 738, the power management system 733 may convert received signals to electrical energy to power the controller 738. Further still, said power may be output from the controller 738 and/or the power management system 733 to power the actuator 760, which may then mechanically move the locking mechanism 780, or portions thereof, to lock or unlock the locking mechanism 780.

In some examples, the locking mechanism 780 and/or the actuator 760 may require greater power levels than those that can be provided by an input wireless signal, directly, and, thus the temporary energy storage device 755 may be included. In such examples, the temporary energy storage device 755 receives the input power from the power management system 733, stores the received power until it reaches a threshold for powering one or both of the actuator 760 and/or the locking mechanism 780, then, when the threshold is met, it discharges the power to actuate the actuator 760. The temporary energy storage device 755 may be or include, for example, a super capacitor tuned to a storage level to power the actuator 760.

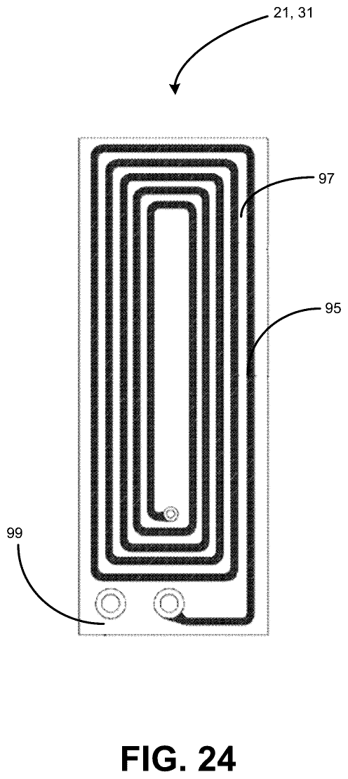

FIG. 24 illustrates an example, non-limiting embodiment of one or more of the transmission antenna 21, the receiver antenna(s) 31, 131A, 131B, 231, 731 that may be used with any of the systems, methods, and/or apparatus disclosed herein. In the illustrated embodiment, the antenna 21, 31, 131A, 131B, 231, 731, is a flat spiral coil configuration. Non-limiting examples can be found in, for example, U.S. Pat. Nos. 9,941,743, 9,960,628, 9,941,743 all to Peralta et al.; 9,948,129, 10,063,100 to Singh et al.; U.S. Pat. No. 9,941,590 to Luzinski; all of which are assigned to the assignee of the present application and incorporated fully herein by reference. The antenna(s) 21, 31, 131A, 131B, 231, 731 illustrated in FIG. 24 may be, but is not limited to being, a printed circuit board (PCB) or flexible printed circuit board (FPC) antenna, having a plurality of turns 97 of a conductor and one or more connectors 99, all disposed on a substrate 95 of the antenna(s) 21, 31, 131A, 131B, 231, 731. While the antenna(s) 21, 31, 131A, 131B, 231, 731 is illustrated, in FIG. 24, having a certain number of turns and/or layers, the PCB or FPC antenna may include any number of turns or layers. The PCB or FPC antenna 21, 31, 131A, 131B, 231, 731 of FIG. 24 may be produced via any known method of manufacturing PCB or FPCs known to those skilled in the art. The antenna(s) 31, 131A, 131B, 231, 731 may take other various forms as well.

While illustrated as individual blocks and/or components of the wireless transmission system 20, one or more of the components of the wireless transmission system 20 may combined and/or integrated with one another as an integrated circuit (IC), a system-on-a-chip (SoC), among other contemplated integrated components. To that end, one or more of the transmission control system 26, the power conditioning system 40, the sensing system 50, the transmission antenna 21, and/or any combinations thereof may be combined as integrated components for one or more of the wireless transmission system 20, the wireless power transfer system 10, and components thereof. Further, any operations, components, and/or functions discussed with respect to the wireless transmission system 20 and/or components thereof may be functionally embodied by hardware, software, and/or firmware of the wireless transmission system 20.

Similarly, while illustrated as individual blocks and/or components of the wireless receiver system 30, one or more of the components of the wireless receiver system 30 may combined and/or integrated with one another as an IC, a SoC, among other contemplated integrated components. To that end, one or more of the components of the wireless receiver system 30 and/or any combinations thereof may be combined as integrated components for one or more of the wireless receiver system 30, the wireless power transfer system 10, and components thereof. Further, any operations, components, and/or functions discussed with respect to the wireless receiver system 30 and/or components thereof may be functionally embodied by hardware, software, and/or firmware of the wireless receiver system 30.

Additionally, while illustrated as individual blocks and/or components of the passive NFMI device 230, one or more of the components of the passive NFMI device 230 may combined and/or integrated with one another as an IC, a SoC, among other contemplated integrated components. To that end, one or more of the components of the passive NFMI device 230 and/or any combinations thereof may be combined as integrated components for one or more of the passive NFMI device 230 and/or components thereof. Further, any operations, components, and/or functions discussed with respect to the passive NFMI device 230 and/or components thereof may be functionally embodied by hardware, software, and/or firmware of the passive NFMI device 230.

Further, while illustrated as individual blocks and/or components of the lock system 700, one or more of the components of the lock system 700 may combined and/or integrated with one another as an IC, a SoC, among other contemplated integrated components. To that end, one or more of the components of the lock system 700 and/or any combinations thereof may be combined as integrated components for one or more of the lock system 700 and/or components thereof. Further, any operations, components, and/or functions discussed with respect to the lock system 700 and/or components thereof may be functionally embodied by hardware, software, and/or firmware of the lock system 700.

With respect to any of the data transmission systems disclosed herein, it should be appreciated that either or both of the wireless power sender and the wireless power receiver may wirelessly send in-band legacy data. Moreover, the systems, methods, and apparatus disclosed herein are designed to operate in an efficient, stable and reliable manner to satisfy a variety of operating and environmental conditions. The systems, methods, and/or apparatus disclosed herein are designed to operate in a wide range of thermal and mechanical stress environments so that data and/or electrical energy is transmitted efficiently and with minimal loss. In addition, the system 10 may be designed with a small form factor using a fabrication technology that allows for scalability, and at a cost that is amenable to developers and adopters. In addition, the systems, methods, and apparatus disclosed herein may be designed to operate over a wide range of frequencies to meet the requirements of a wide range of applications.

While illustrated as individual blocks and/or components of the wireless transmission system 20, one or more of the components of the wireless transmission system 20 may combined and/or integrated with one another as an integrated circuit (IC), a system-on-a-chip (SoC), among other contemplated integrated components. To that end, one or more of the transmission control system 26, the power conditioning system 40, the sensing system 50, the transmission antenna 21, and/or any combinations thereof may be combined as integrated components for one or more of the wireless transmission system 20, the wireless power transfer system 10, and components thereof. Further, any operations, components, and/or functions discussed with respect to the wireless transmission system 20 and/or components thereof may be functionally embodied by hardware, software, and/or firmware of the wireless transmission system 20.

Similarly, while illustrated as individual blocks and/or components of the wireless receiver system 30, one or more of the components of the wireless receiver system 30 may combined and/or integrated with one another as an IC, a SoC, among other contemplated integrated components. To that end, one or more of the components of the wireless receiver system 30 and/or any combinations thereof may be combined as integrated components for one or more of the wireless receiver system 30, the wireless power transfer system 10, and components thereof. Further, any operations, components, and/or functions discussed with respect to the wireless receiver system 30 and/or components thereof may be functionally embodied by hardware, software, and/or firmware of the wireless receiver system 30.

In an embodiment, a ferrite shield may be incorporated within the antenna structure to improve antenna performance. Selection of the ferrite shield material may be dependent on the operating frequency as the complex magnetic permeability (μ=μ′−j*μ″) is frequency dependent. The material may be a polymer, a sintered flexible ferrite sheet, a rigid shield, or a hybrid shield, wherein the hybrid shield comprises a rigid portion and a flexible portion. Additionally, the magnetic shield may be composed of varying material compositions. Examples of materials may include, but are not limited to, zinc comprising ferrite materials such as manganese-zinc, nickel-zinc, copper-zinc, magnesium-zinc, and combinations thereof.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more embodiments, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples of the disclosure. A phrase such an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

Reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub combination or variation of a sub combination. As a further example, it will be appreciated that although UART and the NFC protocols are used as specific example communications schemes herein, other wired and wireless communications techniques may be used where appropriate while embodying the principles of the present disclosure.

What is claimed is:

1. A wireless power receiver system comprising:
an antenna configured to
receive wireless power signals, and
transmit polling signals;
a power conditioning system configured to receive the wireless power signals and convert the wireless power signals to electrical energy for powering a load associated with the wireless power receiver system; and
a controller comprising
a driver;
at least one first non-transitory machine-readable medium; and
program instructions stored on the at least one first non-transitory machine-readable medium that are executable by the controller such that the controller is configured to provide polling driving signals to the driver for generating the polling signals.

2. The wireless power receiver system of claim 1, wherein transmitting the polling signals, by the antenna, includes transmitting the polling signals to a passive antenna of a passive communications system, the passive communications system including the passive antenna and a passive controller.

3. The wireless power receiver system of claim 2, wherein the passive controller comprises:
at least one second non-transitory machine-readable medium; and
program instructions stored on the second non-transitory machine-readable medium that are executable by the passive controller such that the passive controller is configured to modulate the polling signals to encode first data signals in-band of the polling signals.

4. The wireless power receiver system of claim 3, wherein the program instructions stored on the at least one first non-transitory machine-readable medium further include instructions that are executable by the controller such that the controller is configured to demodulate the polling signals to decode the first data signals in-band of the polling signals.

5. The wireless power receiver system of claim 4, wherein the program instructions stored on the at least one first non-transitory machine-readable medium further include instructions that are executable by the controller such that the controller is configured to store the first data signals on one or more of the at least one first non-transitory machine-readable medium, at least one other non-transitory machine-readable medium, or combinations thereof,
wherein the at least one other non-transitory machine-readable medium is operatively associated with the wireless receiver system, a host device associated with the wireless power receiver system, or combinations thereof.

6. The wireless power receiver system of claim 3, wherein receiving the wireless power signals, by the antenna, includes receiving the wireless power signals from a transmitter antenna of a wireless transmission system, and
wherein the wireless transmission system comprises the transmitter antenna and a transmitter controller, the transmitter controller comprising:
at least one third non-transitory machine-readable medium; and
program instructions stored on the at least one third non-transitory machine-readable medium that are executable by the transmitter controller such that the transmitter controller is configured to
generate driving signals for driving the transmitter antenna to transmit the wireless power signals, and
modulate the driving signals to encode second data signals in-band of the wireless power signals.

7. The wireless power receiver system of claim 6, wherein the program instructions stored on the at least one first non-transitory machine-readable medium further include instructions that are executable by the transmitter controller such that the transmitter controller is configured to demodulate the wireless power signals to decode the second data signals.

8. The wireless power receiver system of claim 7, wherein the program instructions stored on the at least one first non-transitory machine-readable medium further include instructions that are executable by the transmitter controller such that the transmitter controller is configured to modulate the wireless power signals to encode third data signals in-band of the wireless power signals.

9. The wireless power receiver system of claim 8, wherein the first data signals are first asynchronous serial data signals and the second data signals are second asynchronous serial data signals, and
each of the first and second asynchronous serial data signals are compliant with a wireless power and data transfer protocol.

10. The wireless power receiver system of claim 9, wherein the first asynchronous serial data signals are first universal asynchronous receiver-transmitter (UART) compliant data signals, and
wherein the second asynchronous serial data signals are second UART compliant data signals.

11. The wireless power receiver system of claim 10, wherein the wireless power and data transfer protocol is a Near Field Communication (NFC) transfer protocol.

12. The wireless power receiver system of claim 1, wherein the wireless power signals and the polling signals each operate at an operating frequency in a range of about 13.553 megahertz (MHz) to about 13.567 MHz.

13. A wireless power and data transfer system comprising:
a wireless transmission system comprising:
a transmitter antenna for transmitting wireless power signals; and
a transmitter controller comprising:
at least one first non-transitory machine-readable medium; and
program instructions stored on the at least one first non-transitory machine-readable medium that are executable by the transmitter controller such that the transmitter controller is configured to generate driving signals for driving the transmitter antenna to transmit the wireless power signals;
a passive communications system comprising:
a passive antenna; and
a passive controller comprising:
at least one second non-transitory machine-readable medium; and
program instructions stored on the second non-transitory machine-readable medium that are executable by the passive controller such that the passive controller is configured to modulate polling signals to encode first data signals in-band of the polling signals; and
a wireless receiver system comprising:
a receiver antenna configured to
receive the wireless power signals, and
transmit the polling signals;
a power conditioning system configured to receive the wireless power signals and convert the wireless power signals to electrical energy for powering a load associated with the wireless power receiver system; and
a receiver controller comprising:
a driver;
at least one third non-transitory machine-readable medium; and
program instructions stored on the at least one third non-transitory machine-readable medium that are executable by the receiver controller such that the receiver controller is configured to provide polling driving signals to the driver for generating the polling signals.

14. The wireless power and data transfer system of claim 13, wherein the passive communication system further comprises a rectifier for converting the polling signal into usable electrical energy for powering the passive controller.

15. The wireless power and data transfer system of claim 13, wherein the program instructions stored on the at least one third non-transitory machine-readable medium further include instructions that are executable by the receiver controller such that the controller is configured to demodulate the polling signals to decode the first data signals in-band of the polling signals.

16. The wireless power and data transfer system of claim 15, wherein the program instructions stored on the at least one third non-transitory machine-readable medium further include instructions that are executable by the receiver controller such that the receiver controller is configured to store the first data signals on one or more of the at least one third non-transitory machine-readable medium, at least one other non-transitory machine-readable medium, or combinations thereof,
wherein the at least one other non-transitory machine-readable medium is operatively associated with the wireless receiver system, a host device associated with the wireless power receiver system, or combinations thereof.

17. The wireless power and data transfer system of claim 13, wherein the program instructions stored on the at least one first non-transitory machine-readable medium further includes instructions that are executable by the transmitter controller such that the transmitter controller is configured to modulate the driving signals to encode second data signals in-band of the wireless power signals.

18. The wireless power and data transfer system of claim 17, wherein the program instructions stored on the at least one third non-transitory machine-readable medium further include instructions that are executable by the receiver controller such that the receiver controller is configured to demodulate the wireless power signals to decode the second data signals.

19. The wireless power and data system of claim 18, wherein the program instructions stored on the at least one third non-transitory machine-readable medium further include instructions that are executable by the receiver controller such that the receiver controller is configured to modulate the wireless power signals to encode data signals in-band of the wireless power signals.

20. The wireless power and data system of claim 19, wherein the wireless power signals and the polling signals each operate at an operating frequency selected from one or more of a first operating frequency, a second operating frequency, a third operating frequency, or combinations thereof,
wherein the first operating frequency is in a range of about 13.553 megahertz (MHz) to about 13.567 MHz,
wherein the second operating frequency is about 6.78 MHz, and
wherein the third operating frequency is in a range of about 88 kilohertz (kHz) to about 1 MHz.
